(19) United States
(12) Patent Application Publication
(10) Pub. No.: US 2026/0172420 A1
(43) Pub. Date: Jun. 18, 2026

(54) SYSTEMS AND METHODS FOR CONTINUOUS IDENTITY VERIFICATION AND DISTRIBUTED LEDGER AUTHORIZATION

(71) Applicant: Aurmor.ai LLC, Winter Garden, FL (US)

(72) Inventors: Justin Dan MATHEW, Raleigh, NC (US); Bradley Shayne FERRINGO, Winter Garden, FL (US); John Patrick RICE, Bethlehem, PA (US)

(21) Appl. No.: 19/418,777

(22) Filed: Dec. 12, 2025

Related U.S. Application Data
(60) Provisional application No. 63/733,882, filed on Dec. 13, 2024.

(51) Int. Cl. H04L 9/40

(52) U.S. Cl. CPC H04L 63/0861; H04L 63/10; H04L 63/20

(57) ABSTRACT

Some examples of the disclosure are directed to systems and methods for continuously authenticating a user and controlling access to user data containers within a ledger-based computing environment. In some aspects, first sensor data associated with a user is received and processed to extract signal features, and compared with stored reference features to determine an accuracy value indicative of verification of a user identity. A first authentication accuracy value is computed based on the accuracy value and, in accordance with a determination that the first authentication accuracy value satisfies a predefined threshold, access to one or more user data containers is authorized. In some aspects, the computing system enables access by an external computing system via a ledger engine and records a transaction in a first ledger.

### CROSS-REFERENCE TO RELATED APPLICATIONS

This application claims the benefit of U.S. Provisional Application No. 63/733,882, filed Dec. 13, 2024, the content of which is hereby incorporated by reference in its entirety for all purposes.

### FIELD OF THE DISCLOSURE

Aspects of the present disclosure relate to computer-implemented systems and methods for continuously identifying and authenticating a user based on sensor data, and authorizing access to one or more user data containers or computing resources in accordance with a ledger-based access policy.

### BACKGROUND OF THE DISCLOSURE

A computer-implemented system can receive sensor data from one or more sensors, determine an authentication accuracy value based on extracted signal features, and record authorized access to user data containers in a ledger.

### SUMMARY OF THE DISCLOSURE

A computer-implemented method comprises receiving, by one or more processors, first sensor data associated with a user, the first sensor data comprising one or more of biometric sensor data and contextual sensor data. The method further comprises extracting, by one or more continuous authentication processes, a plurality of signal features from the first sensor data, and comparing the plurality of signal features with one or more stored reference features extracted from prior data of the user. In accordance with a determination that the plurality of signal features correspond to the one or more stored reference features of the user, the method further comprises determining, by the computing system, via the one or more processors, an accuracy value indicative of verification of a user identity.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an example of a computing system architecture, optionally used to implement one or more of the methods, processes, or systems described herein, in accordance with some examples of the disclosure.

FIG. 2 illustrates an example of a networked computing environment including a display device and a remote device configured to perform distributed processing and authentication, in accordance with some examples of the disclosure.

FIG. 3 illustrates an example of a process for generating an authentication accuracy value and authorizing access to a user data container, in accordance with some examples of the disclosure.

FIG. 4 illustrates an example of an architecture of a user data container and associated data domains, according to some examples of the disclosure.

FIG. 5 illustrates an example of a process for authorizing, denying, and/or recording access to a user data container, based on some examples of the disclosure.

FIG. 6 illustrates an example of a process for generating event metadata labels from sensor data, according to some examples of the disclosure.

FIG. 7A illustrates an example of a process for applying data type analysis to generate personalized analysis outputs, according to some examples of the disclosure.

FIG. 7B illustrates an example of a process for performing an authenticated search of user-specific data stored in one or more user data containers, according to some examples of the disclosure.

FIG. 8 illustrates an example of a process for continuously identifying and authenticating a user to authorize access to one or more user data containers, according to some examples of the disclosure.

FIG. 9 illustrates an example of a process for continuously identifying and authenticating a user to authorize access to one or more user data containers, according to some examples of the disclosure.

FIG. 10 illustrates an example of a process for continuously identifying and authenticating a user to authorize access to one or more user data containers, according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

A computer-implemented method includes receiving, by one or more processors executing on a computing device, sensor data associated with a user and generated by one or more sensors configured for continuous identification and authentication. In some examples, the computing system, via one or more processors, executes one or more continuous authentication processes to extract a plurality of signal features from the sensor data and to compare the plurality of signal features with one or more stored reference features extracted from prior data of the user. In some examples, in accordance with and/or in response to a determination that the plurality of signal features corresponds to the stored reference features, the computing system, via one or more processors, determines an accuracy value indicative of verification of a user identity and compute, based on the accuracy value, an authentication accuracy value representing a probability that the user identity corresponds to an authorized user. As used herein, an “authentication accuracy value” optionally refers to any numeric, categorical, or probabilistic measure derived or computed from a classification or inference model and indicative of confidence that a current authentication attempt corresponds to an enrolled identity. As used herein, “enrolled identity” optionally refers to an identity profile that has been previously registered with the computing system and stored in association with one or more reference features, templates, cryptographic credentials, or models derived from historical biometric data, contextual sensor data, or other identifying information. In some examples, an enrolled identity includes, by way of example and not limitation, a set of biometric reference features, a behavioral pattern model, a device-bound credential, or a user-specific profile that serves as a baseline for subsequent authentication operations.

Additionally or alternatively, in some examples, the continuous identification and authentication protocol executed by the computing system incorporates a multi-stage assessment process in which biometric features (e.g., motion signatures, physiological parameters, or facial embeddings) are fused with contextual attributes (e.g., device-use patterns, ambient conditions, or location cues) to generate a composite identity score. In some examples, the protocol optionally performs temporal consistency checks to confirm that current sensor data aligns with expected usage rhythms for the enrolled identity, or applies challenge-response operations triggered when anomalous patterns are detected. In some examples, the identification and authentication protocol further includes cryptographic confirmation steps in which device-bound keys or signatures associated with the enrolled identity are validated as part of the authentication workflow.

Additionally or alternatively, in some examples, the sensor data includes biometric sensor data and contextual sensor data captured over time while the user interacts with one or more devices. In some examples, the biometric sensor data includes at least one of heart rate data, motion data, muscle activity data, facial feature data, or voice pattern data generated by photoplethysmography sensors, inertial measurement units (IMUs), electromyography sensors, cameras, microphones, or other biometric sensors. In some examples, the contextual sensor data includes at least one of location data, ambient light data, environmental temperature data, device orientation data, or network connectivity data indicating whether a device is connected to a trusted network. Additionally or alternatively, in some examples, the contextual sensor data includes camera or audio data, such as ambient sound patterns, environmental noise signatures, background speech characteristics, or visual ambience cues captured by one or more image sensors. As used herein, “sensor data” optionally refers to any time-series or event-based data collected, detected, and/or produced by a sensor, including biometric, environmental, device-state, or network-related measurements.

In some examples, the plurality of signal features extracted from the sensor data includes motion signatures, physiological parameters, positional patterns, or device-state indicators derived from the sensor data. In some examples, the one or more continuous authentication processes fuses biometric features and contextual features to determine the accuracy value, such as by weighting a motion signature derived from accelerometer data in combination with a device orientation pattern and network connectivity state. As used herein, “fuse” or “fusing” optionally refers to combining, integrating, or otherwise processing two or more data sources, features, or signals. Fusing includes, by way of example and not limitation, concatenation, weighted averaging, statistical aggregation, normalization, dimensionality reduction, feature level merging, or model level integration performed by the one or more processors of the computing system. Additionally or alternatively, in some examples, the continuous authentication processes select a subset of features based on sensor reliability or quality scores and update the feature set over time as additional data is collected.

Additionally or alternatively, in some examples, when the authentication accuracy value satisfies a predefined threshold, the computing system, via the one or more processors, authorizes access to one or more user data containers. In some examples, the computing system communicates with a ledger engine configured to enforce an access policy stored in a first ledger associated with the ledger engine and to grant an external system or application access to the user data containers in accordance with the access policy. As used herein, a “ledger engine” optionally refers to one or more hardware components, software components, or distributed computing processes configured to read from, write to, update, validate, or otherwise manage entries in a ledger, including a blockchain-based or distributed ledger. In some examples, a ledger engine optionally maintains local or remote ledger replicas, executes consensus-related operations, enforces access policies, generates or verifies cryptographic hashes, process transaction submissions, determines ledger synchronization states, or coordinates communication between computing devices and one or more ledgers. Additionally or alternatively, in some examples, a ledger engine optionally interfaces with validator nodes, smart contracts, or other blockchain or ledger management components. As used herein, a “user data container” optionally refers to a logical data structure that groups user-related data and associated metadata, such as health records, laboratory results, legal documents, financial statements, personal content, or generic files, under a persistent container identifier. As used herein, an “access policy” optionally refers to a machine-readable record specifying one or more access parameters, such as identity of permitted external systems, permission levels, duration of access, sharing authorization or synchronization requirements.

In some examples, the ledger engine records, in the first ledger, a cryptographically verifiable transaction corresponding to each authorized access by the external system or application to the user data containers. As used herein, “cryptographically verifiable” optionally refers to a property of a record, transaction, or data object that is validated using one or more cryptographic techniques, such as hashing, digital signatures, message authentication codes, or blockchain-based consensus mechanisms, such that the integrity, authenticity, and non-repudiation of the record can be independently confirmed. In some examples, the transaction includes a timestamp, a reference to the specific user data container accessed, and a cryptographic hash derived or extracted from at least a portion of first sensor data, second sensor data, or both, to cryptographically bind the access event to an authenticity context. Additionally or alternatively, in some examples, the ledger engine is implemented as, or interacts with, a blockchain-based distributed ledger network in which ledger entries are appended as blocks validated by a consensus protocol. As used herein, a “ledger” optionally refers to any append-only data structure that records transactions and associated metadata. As used herein, a “blockchain-based distributed ledger network” optionally refers to a replicated ledger maintained by multiple nodes that agree on transaction ordering using a consensus mechanism.

In some examples, the computing system maintains a second ledger copy stored locally on a device associated with the user, such as a smartphone, wearable device, or home gateway. Additionally or alternatively, in some examples, the second ledger copy is stored on a second digital account associated with another trusted party, such as a healthcare provider, coach, attorney, or other authorized external administrator. In some examples, the computing system periodically verifies synchronization between the second ledger copy and the distributed ledger network by comparing at least one entry of the second ledger copy with at least one entry of the distributed ledger network. Additionally or alternatively, in some examples, when a discrepancy is detected between the first ledger and the one or more ledgers associated with external devices and/or digital accounts associated with the ledger, the computing system automatically revokes or suspends authorization to the user data containers until synchronization to the user data containers is restored.

In some examples, the user data containers further include metadata defining at least one of a data type identifier, a collection timestamp, a sensor source identifier, a data accuracy score, or a contextual tag associated with the data type identifier. In some examples, the computing system automatically generates metadata labels for sensor-derived events, where the metadata labels include at least one of a data type identifier, a contextual category, or a source identifier and are generated without user input based on analysis of one or more characteristics of first and/or second sensor data. In some examples, the generation of metadata labels is user-initiated. Additionally or alternatively, in some examples, the computing system infers an event context, computes a label confidence for an automatically generated label, and assembles an event record only when the label confidence satisfies a label threshold. As used herein, “label confidence” optionally refers to a quantitative or qualitative measure indicating a likelihood that an automatically generated metadata label accurately represents an underlying event, data item, or sensor-derived record. In some examples, label confidence is computed using one or more statistical models, rule-based classifiers, machine learning models, probability scores, similarity metrics, or fusion of multiple signals derived or extracted from biometric data, contextual sensor data, or metadata patterns.

Additionally or alternatively, in some examples, the computing system exposes a metadata search interface that receives a user-provided input (e.g., description or one or more keywords) corresponding to the metadata of the user data containers. In some examples, the user-provided input is not itself required to form part of the metadata label, and the metadata label is instead optionally generated by the one or more processors based on analysis of sensor data, contextual data, or prior container content. Additionally or alternatively, in some examples, the computing system incorporates at least a portion of the user-provided input into the metadata label when such input is determined to increase accuracy or relevance of subsequent retrieval operations. In some examples, a search engine model analyzes the metadata labels and generate a summary output identifying one or more user data containers that satisfy a query defined by the user description or keywords. In some examples, the summary output includes file identifiers, container identifiers, or synthesized summaries of content derived from the metadata of the matching user data containers. As used herein, a “search engine model” optionally refers to a rule-based or machine-learning model configured to evaluate query terms against stored metadata and to rank or filter user data containers based on relevance.

In some examples, the user data containers are associated with one or more metadata records that link the user data containers to multiple ledgers corresponding to different data domains, such as healthcare legal, financial, or personal data ledgers. In some examples, the computing system maintains interoperability across multiple domains by storing cross-ledger identifiers in the metadata so that an access event record in one ledger can be correlated with relate entries in other ledgers. Additionally or alternatively, in some examples, the computing system generates an authentication accuracy value above the threshold triggers a secondary action, such as generating an alert, prompting the user for confirmation of a sensitive operation, initiating a session teardown (e.g., termination of session) for an anomalous access attempt, locking a particular data container, or requiring re-authentication when the continuous authentication model detects a potential change in primary or secondary identity.

In some examples, the computing system prompts a user (e.g., via one or more processors), through a user interface, to define one or more access parameters associated with sharing a user data container with an external system. In some examples, the access parameters include at least one of a duration, a permission level, a sharing authorization, or identification of an external user or external system. Additionally or alternatively, in some examples, the permission level is selected from a set of read-only, write-only, or read-write access levels to control whether an external system can merely view content, append new content, or both view and modify existing content within a user data container. In some examples, the access policy stored in the ledger encodes these access parameters as part of a smart contract that automatically enforces sharing terms and triggers synchronization events.

Additionally or alternatively, in some examples, the computing system enables the user to specify an external user that gains access to one or more user data containers for a defined duration, such as a healthcare provider accessing medical records for a limited treatment window, a sports coach reviewing athletic records for a new student, or a financial advisor reviewing financial documents for a specified project. In some examples, the access policy defines an expiration time or event, and the ledger engine automatically revokes authorization once the defined duration lapses without requiring manual intervention. As used herein, “external user” optionally refers to any individual or entity distinct from the primary user whose identity is separately authenticated through the continuous authentication framework or another credentialing mechanism.

In some examples, a third-party application operates as an authorized external system and accesses one or more user data containers through one or more smart contracts and/or one or more application programming interfaces. In some examples, the third-party application executes on the same processor as the continuous authentication processes or on a separate device connected via a network, provided that all access requests are mediated by the ledger engine and recorded in the ledger. Additionally or alternatively, in some examples, the third-party application behaves like an external user with respect to the access policy.

In some examples, a method for dynamic sensor position awareness and authentication includes receiving, by one or more processors, sensor data from one or more sensors associated with a wearable electronic device, such as a watch, earbud, ankle band, or chest strap. In some examples, sensor data is received from one or more head-mounted sensors for the collection of impact related data as related to the wearer of the device. In some examples, a head-mounted sensor is worn at or in near proximity to an ear of the user, and/or in contact with or in near proximity to the occipital lobe of the user. In some examples, the computing system analyzes movement data derived or extracted from the sensor data to determine a sensor position on a body of the user, for example by comparing observed motion signatures to stored models for wrist motion, head motion, or gait. Additionally or alternatively, in some examples, based on the determined sensor position, the computing system selects a corresponding identification or authentication model from a plurality of stored models, each stored model being associated with a different sensor position, and execute the selected model using the sensor data to determine an authentication accuracy value associated with the user. As used herein, a “sensor position” optionally refers to a region or mounting location on the body that impacts observed sensor characteristics, such as wrist, ankle, chest, ear or torso.

In some examples, a method for secure file sharing includes receiving, by one or more processors, a request to encrypt a file associated with a user data container and encrypting the file to form a non-capable data object. In some examples, the non-capable data object is associated with a unique identifier stored in a ledger, and the computing system provides access to the non-capable data object by transmitting to one or more external devices a pointer to the non-capable data object rather than a full copy of the underlying file. As used herein, a “non-capable data object” optionally refers to an encrypted or otherwise encapsulated data representation that is not independently usable or interpretable without access to decryption keys or container context.

In some examples, the computing system verifies, via the ledger, synchronization between a first ledger associated with a local device and one or more ledgers associated with the external devices that have pointed to the non-capable data object. In some examples, in accordance with a determination that the first ledger and the one or more ledgers are synchronized, the computing system maintains access to the non-capable data object and allows continued sharing or processing by the external devices. Additionally or alternatively, in some examples, in accordance with and/or in response to a determination that the first ledger and the one or more ledgers are out of synchronization, the computing system suspends sharing of the non-capable data object, revoke outstanding access tokens, and update the ledger entries before re-enabling access.

In the following descriptions, an electronic device that communicates with one or more displays and input devices is discussed. It is understood that the electronic device optionally communicates with other physical user-interface devices such as a touch-sensitive surface, a physical keyboard, a mouse, a joystick, a hand tracking device, an eye tracking device, a stylus, etc. Furthermore, as previously mentioned, the electronic device, display, and touch-sensitive surface is distributed across multiple devices. Therefore, as used in this disclosure, information displayed on or by the electronic device optionally refers to information outputted by the electronic device for display on a separate display device (whether touch-sensitive or not). Similarly, input received on the electronic device (e.g., touch input on a touch-sensitive surface of the electronic device or on the surface of a stylus) optionally refers to input received on a separate input device from which the electronic device receives input information.

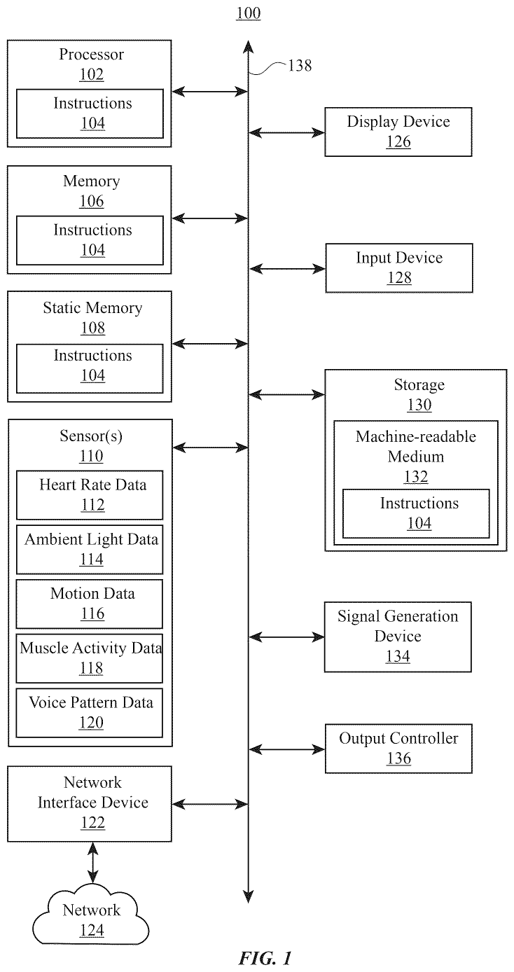

FIG. 1 illustrates an example of a computing system 100 optionally used to implement one or more of the methods, processes, or systems described herein, in accordance with some examples of the disclosure. In some examples, a computing system 100 includes a processor 102, memory 106, static memory 108, one or more sensor(s) 110, a network interface device 122, a display device 126, an input device 128, a storage 130 containing a machine-readable medium 132, a signal generation device 134, an output controller 136, and a network interface device 122 coupled via an interlink 138. In some examples, the processor 102 includes one or more processing units configured to execute instructions 104 stored in one or more of the memory 106, static memory 108, or storage 130. The instructions 104 optionally include program code executable by the processor 102 to perform any of the functions described herein, including signal processing, sensor data classification, authentication accuracy computation, or ledger synchronization.

Additionally or alternatively, in some examples, the memory 106 includes volatile memory (e.g., random access memory) configured to temporarily store active data or working variables used during computation, such as shown in FIG. 1 for instance. The static memory 108 optionally includes non-volatile memory (e.g., read-only memory or flash memory) that stores firmware, configuration parameters, or baseline reference data used by the computing system for comparison or authentication purposes. The storage 130 optionally includes the machine-readable medium 132 on which the instructions 104 is optionally be stored. In some examples, the computing system optionally uses the machine-readable medium 132 to store program code for performing operations such as model selection, accuracy value determination, or authorization control. Additionally or alternatively, in some examples, the machine-readable medium 132 stores user data containers, identification models, authentication models, or ledger entries associated with user identity verification.

In some examples, such as shown in FIG. 1, the sensor(s) 110 optionally includes one or more sensing devices configured to detect physiological, environmental, or contextual signals associated with a user. For example, the sensor(s) 110 includes sensors configured to generate heart rate data 112, ambient light data 114, motion data 116, muscle activity 118, and voice pattern data 120. Additionally or alternatively, in some examples, the sensor(s) 110 includes optical, inertial, proximity, or biometric sensors integrated into or coupled to a wearable device, computing accessory, or mobile device.

In some examples, such as shown in FIG. 1, the network interface device 122 is configured to facilitate wired or wireless communication between the computing system 100 and one or more external systems, such as servers, ledgers, or distributed networks. Additionally or alternatively, in some examples, the network interface device 122 enables synchronization of ledger entries, authentication states, or user data containers across multiple devices.

The display device 126 optionally includes one or more displays, such as liquid crystal displays (LCDs), organic light-emitting diode (OLED) displays, or micro-LED panels, configured to present information such as user prompts, authentication feedback, or system alerts. In some examples, such as shown in FIG. 1, the input device 128 includes one or more touchscreens, keypads, microphones, gesture sensors, or other input components that enable user interaction with the computing system. In some examples, the signal generation device 134 includes one or more haptic actuators, speakers, or indicator lights configured to provide user feedback corresponding to system states, such as successful authentication or synchronization failure. Additionally or alternatively, in some examples, the output controller 136 manages and coordinates output signals among the display device 126, signal generation device 134, and other peripheral output components.

The interlink 138, in some examples, represents one or more internal communication buses or pathways coupling the components of the computing system 100 via a network 124. In some examples, the interlink 138 includes one or more communication protocols, such as USB, SPI, or PCIe. In some examples, such as shown in FIG. 1, the interlink 138 optionally facilitates bidirectional data exchange between the processor 102, sensor(s) 110, and other system components. Additionally or alternatively, in some examples, the computing system 100 optionally operates as part of a distributed computing environment, where one or more of the processor 102, memory 106, or storage 130 are implemented on a remote server, cloud computing resource, or ledger engine, while the sensor(s) 110 and input/output components are implemented locally on a wearable or mobile device.

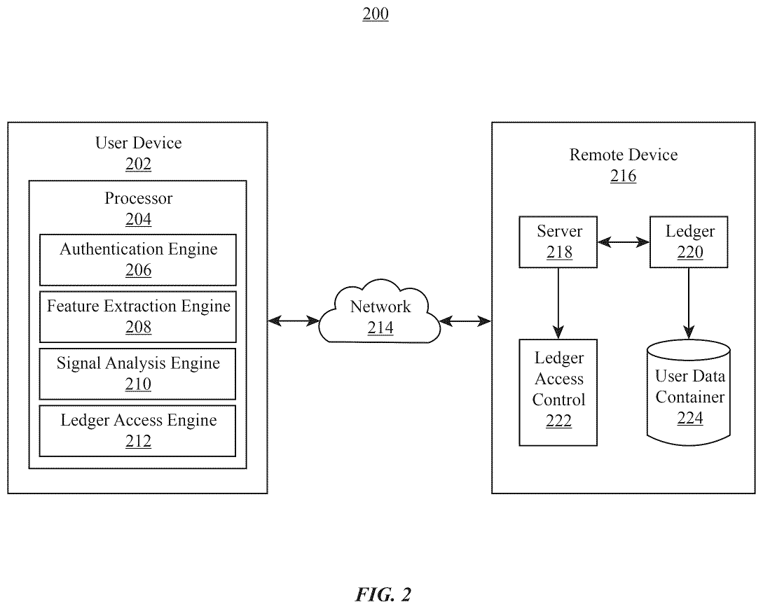

FIG. 2 illustrates an example of a networked computing environment 200 including a user device and a remote device configured to perform distributed processing and authentication, in accordance with some examples of the disclosure. In some examples, a user device 202 includes a processor 204 configured to execute instructions 104 associated with an authentication engine 206, a feature extraction engine 208, a signal analysis engine 210, and a ledger access engine 212. In some examples, the authentication engine 206 performs continuous or event-based verification of a user identity based one or more signal features extracted from sensor data, such as biometric motion or contextual signals.

Additionally or alternatively, in some examples, such as shown in FIG. 2, the feature extraction engine 208 is configured to extract a plurality of signal features from raw sensor data associated with the user. The extracted features include signal magnitudes, phase shifts, amplitude ratios, frequency components, or statistical measures representative of user movement, physiological activity, or environmental conditions. In some examples, the signal analysis engine 210 analyzes the extracted features in accordance with stored reference features or prior authentication data. In some examples, the signal analysis engine 210 computes one or more accuracy values indicative of user identity verification confidence, probability of a math, or session continuity.

Additionally or alternatively, in some examples, such as shown in FIG. 2, the ledger access engine 212 manages communication between the user device 202 and one or more remote ledgers through the network 124. The ledger access engine 212 optionally, in some examples, verifies authorization policies, synchronizes data entries, or updates transaction logs in accordance with user identity validation results. In some examples, the remote device 216 includes a server 218 that communicates with a ledger 220 through a ledger access control node 222. The ledger access control node 222 optionally enforces predefined access policies or validation conditions associated with one or more user data containers.

In some examples, the ledger 220 maintains immutable transaction records corresponding to access requests, authorizations or identity verification events. Additionally or alternatively, in some examples, the ledger 220 includes a distributed or blockchain-based data structure to maintain data integrity and consistency across multiple participating nodes. In some examples, such as shown in FIG. 2, the user data container 224 stores user-specific data, such as authentication profiles, sensor data histories, or model parameters used to determine accuracy values. In some examples, the user data container 224 is updated in response to successful authentication events or synchronization processes initiated by the ledger access engine 212.

In some examples, the network 124 represents a local area network, a wide area network, a wireless communication network, or a combination thereof, to facilitate data transfer between the user device 202 and the remote device 216. In some examples, such as shown in FIG. 2, the networked computing environment 200 implements distributed functionality wherein the feature extraction engine 208 and signal analysis engine 210 operate locally on the user device 202, while the authentication engine 206 or ledger access engine 212 can, in some examples, cooperate with remote processes executed by the server 218 and managed via the ledger 220. In some examples, synchronization between the user device 202 and the remote device 216 occurs periodically or in response to an authentication event. In some examples, in accordance with and/or in response to a determination that a computed authentication accuracy value satisfies a predefined threshold, the ledger 220 records a corresponding transaction entry authorizing access to the user data container 224.

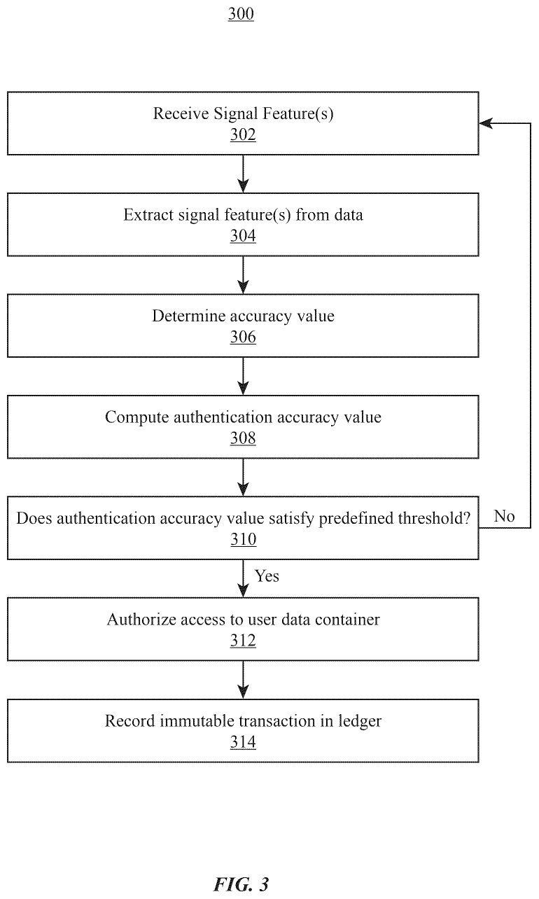

FIG. 3 illustrates an example of a process 300 for generating an authentication accuracy value and authorizing access to a user data container, in accordance with some examples of the disclosure. An example of process 300 begins at operation 302, where the computing system (e.g., computing system 100 as described with respect to FIG. 1) receives one or more signal features. In some examples, the signal features are received from one or more of the sensor(s) 110 described with reference to FIG. 1, such as biometric, motion, or contextual sensors. The received signal features includes, for example, heart rate data, muscle activity data, voice pattern data, or motion-based inertial data captured from a wearable or mobile device associated with the user. Additionally or alternatively, in some examples, the received signal features includes pre-processed data transmitted from a remote or distributed sensing module configured to detect user-specific signals indicative of a physiological or behavioral pattern.

In some examples, such as shown in FIG. 3 at operation 304, the computing system extracts one or more signal features from data. In some examples, the extracted features includes amplitude, frequency, phase, or displacement characteristics extracted from the received sensor data. For example, the feature extraction engine 208 (as described with respect to FIG. 2) optionally isolates temporal changes in motion magnitude or spatial displacement patterns corresponding to muscle contraction, gait periodicity, respiration-induced body motion or limb orientation. Additionally or alternatively, in some examples, the extraction process involves filtering noise (e.g., removing high-frequency electrical interference, or attenuating motion-artifact spikes caused by abrupt limb movement), segmenting raw data streams, or performing feature normalization to prepare the signals for subsequent comparison and accuracy analysis. As used herein, “feature normalization” optionally refers to scaling, transforming, or statistically standardizing extracted features such that they are comparable across sensor sessions, hardware platforms, or environmental conditions. For example, feature normalization optionally includes min-max scaling, z-score normalization, percentile mapping, histogram equalization, or transforming temporal features to a frequency domain prior to comparison.

In some examples, such as shown in FIG. 3 at operation 306, the computing system determines an accuracy value. As used herein, an “accuracy value” optionally refers to a measure of how well extracted features correspond to stored reference features, without yet making a final determination as to user identity. In some examples, the accuracy value is computed by comparing the extracted signal features with one or more stored reference features associated with the user, such as a baseline movement profile or biometric pattern maintained within the user data container 224. In some examples, the accuracy value corresponds to a degree of similarity, correlation coefficient, or classification confidence level between the current and stored feature sets. Additionally or alternatively, in some examples, the accuracy value represents a probabilistic measure of how well the input features align with a unique pattern of an authorized user as modeled by a personalized authentication model.

In some examples, such as shown in FIG. 3 at operation 308, the computing system computes an authentication accuracy value based on the previously determined accuracy value. As used herein, an “authentication accuracy value” optionally refers to a refined or derived metric generated after additional processing, such as fusion with contextual data, threshold comparison, or continuous authentication logic, to determine whether access to a user data container should be authorized or revoked. In some examples, the authentication accuracy value represents an aggregated or weighted probability score that the user identity corresponds to an authorized user. For example, the computing system optionally employs a continuous multi-factor identification and authentication model (CMFIA) that integrates biometric, contextual, and behavioral signals to produce a composite confidence score. Additionally or alternatively, in some examples, the computed authentication accuracy value is updated continuously over time according to one or more triggering conditions. In some examples, the computing system recalculates the authentication accuracy value at fixed temporal intervals (example e.g., intervals of less than one second, 1 second, 3 seconds, 15 seconds, 30 seconds, 1 minute, 5 minutes, 30 minutes, 60 minutes, or more than 60 minutes), every few seconds or minutes). Additionally or alternatively, in some examples, the authentication accuracy value is updated on an incident-driven basis in response to detecting one or more new sensor events, contextual changes, or system-level actions that can influence identity confidence. In some examples, both time-based and event-based triggers are used such that the authentication accuracy value remains responsive to ongoing biometric and contextual signals.

In some examples, such as shown in FIG. 3 at operation 310, the computing system determines whether the authentication accuracy value satisfies a predefined threshold. The predefined threshold optionally corresponds to, in some examples, a minimum confidence level is required to verify user identity and authorize access to secure data resources. For example, if the authentication accuracy value exceeds a stored threshold value (e.g., less than 50%, 50%, 65%, 75%, 95%, more than 95%), the user is, in some examples, considered authenticated. In some examples, if the authentication accuracy value does not satisfy the threshold, access to the user data container 224 is denied or restricted. Additionally or alternatively, in some examples, the threshold is adaptive, adjusting dynamically based on historical accuracy scores, environmental factors, or context inferred from concurrent sensor inputs.

In some examples, referencing FIG. 3, if the threshold is satisfied (YES at 310), the computing system proceeds to operation 312, where the computing system authorizes access to the user data container 224. In some examples, authorization involves generating a temporary access token, unlocking a portion of user data, or enabling read/write privileges for a verified external application. Additionally or alternatively, in some examples, authorization is contingent upon verification through a ledger access engine 212 (see FIG. 2) that confirms the validity of the identity of the user within a distributed ledger 220.

In some examples, referencing FIG. 3, following successful authorization, the computing system proceeds to operation 314, where the computing system records an immutable transaction in the ledger. In some examples, the recorded transaction includes metadata describing the authentication event, such as the timestamp, device identifier, computed authentication accuracy value, and the access action performed. Additionally or alternatively, in some examples, the ledger record triggers synchronization of access policies. In some examples, the ledger record updates the state of the user data container 224 to reflect that access has been granted in accordance with verified authentication conditions.

In some examples, referencing FIG. 3, in response to determining that the authentication accuracy value does not satisfy the predefined threshold (NO at 310), the computing system maintains a restricted access state. As used herein, a “restricted access state” optionally refers to a system condition in which access to one or more user data containers is temporarily limited, suspended, or constrained. In some examples, the restricted access state prevents read and/or write operations until the system re-establishes required authentication confidence or ledger consistency. In some examples, the computing system optionally initiates a retraining of the recalibration process to improve model accuracy for future attempts. Additionally or alternatively, in some examples, the computing system notifies the user or an administrator of repeated failed authentications. In some examples, the computing system temporarily suspends synchronization of ledger updates to prevent unauthorized access propagation.

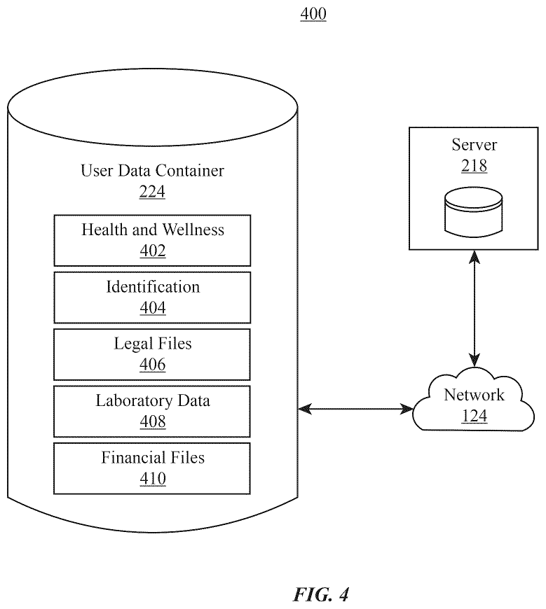

FIG. 4 illustrates an example architecture 400 of a user data container and associated data domains, according to some examples of the disclosure. In some examples, the user data container 224 is communicatively coupled to a server 218 via a network 124. In some examples, the user data container 224 includes one or more sub-containers that stored categorized information associated with a user. For example, each of the sub-containers optionally represents a logical partition, data domain, or data ledger entry corresponding to a particular aspect of the user's personal, legal, financial, or health information.

In some examples, referencing FIG. 4, a health and wellness container 402 includes physiological or contextual data collected from one or more biometric sensors. The health and wellness container 402 optionally stores heart rate data, respiration rate, motion or activity data, sleep patterns, body temperature data, or ambient environmental readings captured by a wearable or mobile device. Additionally or alternatively, in some examples, the health and wellness container 402 includes contextual metadata such as timestamps, device orientation, or environmental conditions that provide additional meaning to physiological measurements. In some examples, the health and wellness container 402 further includes a biometric profile used for continuous authentication, including features extracted from motion signatures, facial characteristics, or voice patterns.

In some examples, referencing FIG. 4, an identification container 404 stores one or more identifiers associated with the user. For example, the identification container 404 includes a user name, device ID, digital certificate, image likeness, or biometric identifier such as a facial embedding or voice signature. Additionally or alternatively, in some examples, the identification container 404 includes an encrypted copy of government-issued identification (e.g., driver's license, passport, or national ID) or a watermark linking the user's identity to corresponding biometric or contextual data. As used herein, a “watermark” optionally refers to a digital watermark embedded imperceptibly within an electronic record, a visible or semi-visible watermark displayed within an image or document, or a digital representation of a visual watermark applied to identification records. Additionally or alternatively, in some examples, the watermark encodes identity-specific attributes derived from biometric and contextual features to enable future verification of authentication. In some examples, an access policy associated with the identification container 404 is recorded in a distributed ledger maintained by the server 218 or a remote ledger engine.

In some examples, referencing FIG. 4, a legal files container 406 stores documents and metadata associated with legal records, contracts or licensing information. The legal files container 406 includes user-authorized documents such as wills, power of attorney forms, or intellectual property agreements, in some examples. Additionally or alternatively, in some examples, the legal files container 406 stores encrypted communications between the user and legal counsel, or records of notarized transactions recorded to a blockchain-based distributed ledger. In some examples, access to the legal files container 406 is subject to a smart-contract-based access policy enforcing time-limited or read-only permissions to authorized parties.

In some examples, referencing FIG. 4, a laboratory data container 408 stores diagnostic or analytical data generated by third-party testing systems. The laboratory data container 408 includes clinical test results, sensor calibration files, or quality assurance reports associated with the user, in some examples. Additionally or alternatively, in some examples, the laboratory data container 408 includes contextual tags indicating test type, collection type, and data reliability score. In some examples, when the laboratory data container 408 is shared externally, a transaction is recorded to the ledger identifying the recipient, timestamp, and immutable cryptographic hash of the shared data.

In some examples, referencing FIG. 4, a financial files container 410 stores records relating to the user's financial activities, including account information, transaction histories, or digital asset holdings. Additionally or alternatively, in some examples, the financial files container 410 includes payroll documents, tax records, or insurance documentation linked to the user. In some examples, access to the financial files container 410 requires multi-factor authentication based on both biometric and contextual sensors, and transactions related to financial files are recorded to a blockchain ledger for auditability.

In some examples, referencing FIG. 4, the server 218 is configured to store, synchronize, or validate access to one or more user data containers 224 through the network 124. The server 218 optionally further executes a ledger engine configured to maintain an immutable record of access events, synchronization states, or authorization expirations, in some examples. Additionally or alternatively, in some examples, the server 218 hosts a smart contract engine that enforces access terms such as duration, permission level, or data sharing authorization defined by the user.

In some examples, referencing FIG. 4, the network 124 includes a local, cloud-based, or distributed communication network. In some examples, the network 124 further supports synchronization of local and remote ledger copies to ensure that updates to the one or more user data containers 224 are consistent across multiple devices and/or systems. Additionally or alternatively, in some examples, each of the sub-containers includes a watermark identifier imperceptibly encoded within stored data to preserve authenticity and attribution when shared externally. In some examples, the watermark identifier is generated based on biometric data associated with the user, contextual data associated with the user, or both. In some examples, the watermark identifier persists across sharing events.

In some examples, the computing system enables an enrolled user to establish an organization within the platform and to add or enroll additional users, devices, and data containers with that organization. In some examples, an enrolled user connects external sensory devices to a platform computing device, such as a mobile phone, tablet, laptop, personal server, or cloud-connected system, using wired or wireless communication. Additionally or alternatively, in some examples, sensor data collected from these external devices is processed and classified into biometric, contextual, behavioral, or device-state labels and stored in a continuous multi-factor identification and authentication container. In some examples, the enrolled user configures a required quantity or diversity of sensor data needed for identification and authentication and optionally defines security parameters such as automatic logoff after a predetermined number of disconnections or deviations from expected statistical patterns. In some examples, once configured, the enrolled user transitions into an active user state that enables organization-level actions.

Additionally or alternatively, in some examples, an active user creates an organization and adds members, data containers, or files to shared organizational spaces. In some examples, each action performed by the active user is recorded into a ledger associated with the organization, and any added files are stored into the appropriate user data containers with corresponding digital watermarks and container-level metadata. In some examples, system applications approved by the active user execute analyses on container data, with the resulting outputs written into a system application data container and, optionally, recorded into the ledger. In some examples, an active user may optionally permit other members of the organization to view these analyses through access-controlled interfaces.

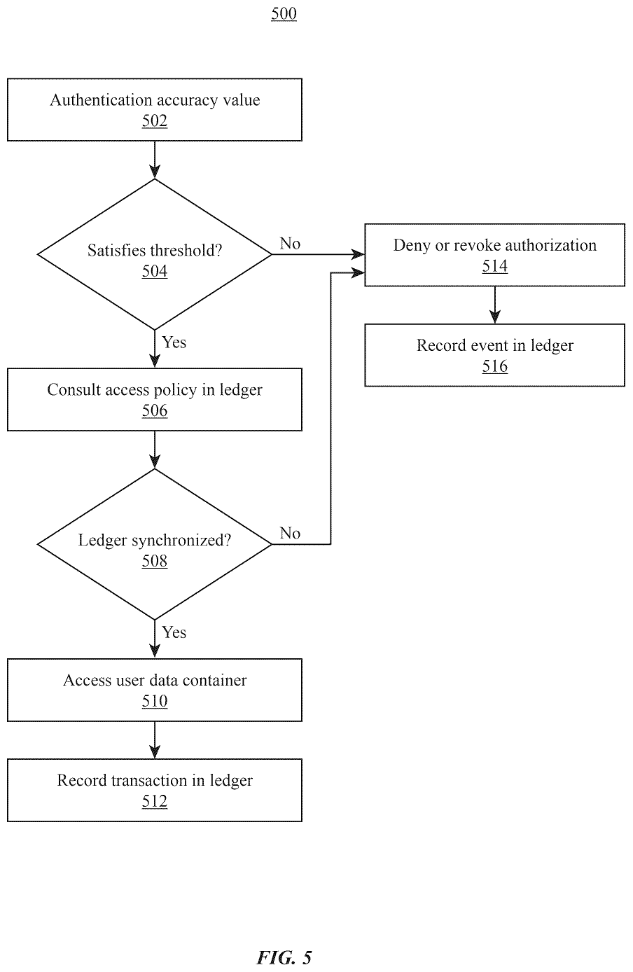

FIG. 5 illustrates an example of a process 500 for authorizing, denying, and/or recording access to a user data container, based on some examples of the disclosure. In some examples, the process 500 is executed by one or more processors configured to perform operations 502-516. Authenticating users and/or ledger copies to control access-controlled data such as by determining whether an authentication accuracy value satisfies a threshold, authorizing or revoking access based on that determination, and recording the resulting event or transaction in a ledger improves data privacy, data security, and/or maintains data fidelity by confirming access is authorized and/or limiting the manner in which that potentially sensitive information can be accessed.

In some examples, referencing FIG. 5, at operation 502, the computing system (e.g., computing system 100 as described with respect to FIG. 1) receives an authentication accuracy value which optionally shares one or more characteristics with the authentication accuracy value referred to herein. In some examples, the authentication accuracy value is generated according to a continuous authentication process and represents a probability that a user identity corresponds to an authorized user. The authentication accuracy value is, in some examples, computed based on features extracted from biometric or contextual sensor data, such as motion signatures, muscle activity patterns, heart rate, or device orientation information. Additionally or alternatively, in some examples, the authentication accuracy value is computed by a comparison of current sensor data against one or more stored reference features generated during a model training phase.

In some examples, referencing FIG. 5, at operation 504, the computing system determines whether the authentication accuracy value satisfies a predefined threshold, wherein the predefined threshold optionally shares one or more characteristics with the stored threshold value referred to herein. As used herein, “threshold” optionally refers to a predefined numerical, statistical, or rule-based value or condition against which a computed metric, such as an accuracy value, authentication accuracy value, or label confidence, is evaluated to determine whether a corresponding operation is permitted, denied, or modified. Additionally or alternatively, in some examples, a “predefined threshold” is fixed, user-configurable, or dynamically adjusted over time based on historical performance data, or derived from machine-learning model parameters that specify a minimum acceptable confidence level for verification or authorization. In some examples, the threshold is user-defined, dynamically adaptive, or dependent on context. For example, a higher threshold is required when accessing financial or legal data, while a lower threshold optionally suffices for non-sensitive operations.

In some examples, referencing FIG. 5, the authentication accuracy value satisfies the threshold (YES at 504), the process proceeds to operation 506, in which the computing system consults an access policy stored in a ledger. In some examples, the ledger is a blockchain-based distributed ledger network, and the access policy is implemented as a smart contract automatically enforcing sharing terms, synchronization events, and authorization expiration conditions. Additionally or alternatively, in some examples, the access policy defines access parameters such as permission level (read-only, write-only, or read-write), authorized duration, or identity of external users permitted to act on behalf of the authenticated user.

In some examples, referencing FIG. 5, at operation 508, the computing system determines whether the ledger is synchronized. In some examples, synchronization includes verifying that a local ledger copy matches a distributed ledger network or that all participating nodes have recorded consistent access transaction states. Additionally or alternatively, in some examples, the verification involves comparing timestamps, transaction hashes, or block identifiers across multiple ledger copies. As used herein, such comparison optionally relies on a synchronization threshold that specifies an allowable deviation, such as a maximum permissible timestamp drift or sequence offset, beyond which the ledgers are deemed out of synchronization. Additionally or alternatively, in some examples, verification of ledger synchronization does not require the timestamps to match exactly but instead requires that the measured deviation fall within the predefined synchronization threshold to account for network latency, propagation delays, or asynchronous block-commit intervals.

In some examples, referencing FIG. 5, if the ledger is synchronized (YES at 508), the process continues to operation 510, where the computing system authorizes access to the user data container. In some examples, authorization permits a local or remote application, server, or smart contract engine to access specific container data, such as health, legal, or financial records, in accordance with the access policy. In some examples, at operation 512, the computing system records a corresponding transaction in the ledger. The recorded transaction includes a timestamp, cryptographic hash, user identifier, or access context metadata, in some examples.

In some examples, referencing FIG. 5, if the ledger is not synchronized (NO at 508), the process proceeds to operation 514, where the computing system denies or revokes authorization. In some examples, revocation occurs automatically to prevent data divergence until synchronization is restored. Additionally or alternatively, in some examples, the computing system applies secondary actions, including session teardown, container lockout, or prompting the user for re-authentication. In some examples, following revocation, at operation 516, the computing system records an event in the ledger. In some examples, if, at operation 504, the authentication accuracy value does not satisfy the threshold (NO at 504), the computing system also proceeds to operation 514 to deny or revoke authorization, followed by operation 5126 to record the event in the ledger.

In some examples, referencing FIG. 5, the process 500, further includes actions such as generating a user notification when repeated authentication failures occur, initiating automatic teardown of external sessions, or enforcing expiration of temporary access tokens previously granted to external users. Additionally or alternatively, in some examples, when a watermark identifier is associated with a user data container, denial or authorization events recorded in the ledger includes reference metadata linking the watermark identifier to the affected transaction.

In some examples, once a user is identified and authenticated, the computing system (e.g., computing system 100 as described with respect to FIG. 1) supports adding wearable or stationary devices into an organization associated with the user. In some examples, the active user configures the relationship between each device and the platform. For example, the device is optionally a wearable device configured to provide biometric sensor outputs usable within the CMFIA protocol, or a home surveillance camera and microphone configured to contribute facial or vocal recognition outputs. In some examples, each associated sensor data stream becomes part of the user identification or authentication data stored in the appropriate container.

Additionally or alternatively, in some examples, a user adds devices whose data are ingested into a health data container or another specialized container. The resulting data is optionally recorded into the ledger, and if other authorized users have access permissions to the corresponding container, synchronization notifications are transmitted to those users'ledger copies. In some examples, the added device is a stationary network-connected appliance, such as a dishwasher or HVAC system, which communicates with the platform computing device using application-specific identifiers. In some examples, an active user interacts with such devices using user interfaces executed within the platform (e.g., buttons, text inputs, sliders, or voice commands).

In some examples, the computing system identifies compromised devices within an organization by monitoring attempted access events that fail the CMFIA protocol. In some examples, when an access attempt fails, the computing system transmits notifications to devices associated with authorized users describing the anomalous event. If an authorized device fails to respond or to confirm that the access attempt is legitimate, the computing system optionally classifies the originating device as compromised. In some examples, once classified as compromised, the device is placed into a restricted access state, preventing it from interacting with shared data containers or organization-level ledgers. Additionally or alternatively, in some examples, authorized users receive a notification prompting them to make a decision as to whether to revoke the compromised device's access. In some examples, if no action is taken within a defined duration, the compromised device is automatically instructed to migrate uncompromised data to another approved device and to clear its own container data.

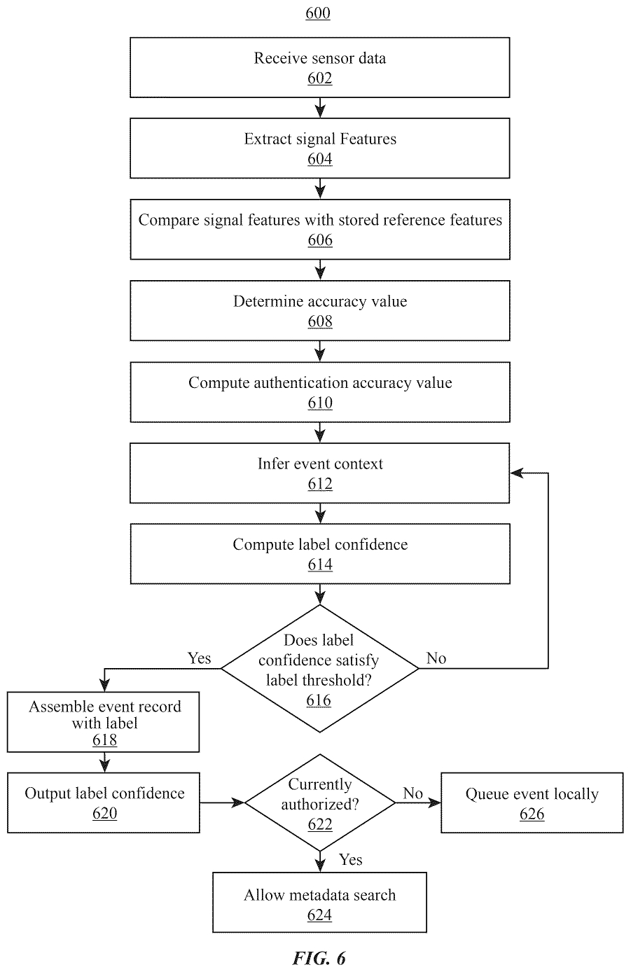

FIG. 6 illustrates an example of a process 600 for generating event metadata labels from sensor data, according to some examples of the disclosure. Authenticating users and/or ledger copies to control access-controlled data such as by computing a label confidence for inferred event context, comparing the label confidence to a predefined threshold, and gating metadata search functionality based on that comparison improves data privacy, data security, and/or maintains data fidelity by confirming access is authorized and/or limiting the manner in which that potentially sensitive information can be accessed. In some examples, process 600 begin at operation 602, where one or more processors receive sensor data associated with a user. In some examples, the sensor data received at operation 602 corresponds to first sensor data as described with respect to FIG. 2, and includes biometric sensor data, contextual sensor data, or combinations thereof. For example, the sensor data includes heart rate data, motion data, muscle activity data, facial feature data, breath pattern or voice pattern data. In some examples, the contextual sensor data includes contextual information such as device orientation, ambient light, environmental temperature, or network connectivity at the time of the event. Additionally or alternatively, in some examples, operation 602 includes receiving streams of sensor data from multiple sensor devices positioned at different locations on a user's body (e.g., wrist, ankle, or head-mounted devices) or in the user's environment. In some examples, the sensor data is received in real time during an authentication session and/or during background monitoring for subsequent labeling and storage in one or more user data containers.

In some examples, referencing FIG. 6, process 600 proceeds to operation 604, where the computing system extracts signal features from the received sensor data. In some examples, the extracted signal features at operation 602 includes, for example, motion signatures, physiological parameters, positional patterns, and device-state indicators derived or extracted from the biometric sensor data and/or contextual sensor data. The feature extraction performed at operation 604 can, in some examples, correspond to the continuous authentication feature extraction described with respect to FIG. 2, and is implemented by a feature extraction engine operating on the user device, a remote device, or both.

Additionally or alternatively, in some examples, referencing FIG. 6, operation 604 includes performing frequency-domain transforms, temporal windowing, filtering, or other signal processing techniques to extract signal features suited for user identification, activity classification, or event-type labeling. For example, the feature extraction optionally computes statistical summaries over time windows (e.g., mean heart rate or variance of motion), generate embeddings using machine learning models, or extract inferred features corresponding to user movements such as step cadence, arm motions (e.g., golf swing), skiing related features, and/or chewing events.

In some examples, referencing FIG. 6, process 600 advances to operation 606, where the extracted signal features are compared with one or more stored reference features. The stored reference features at operation 606 can, in some examples, be extracted from prior data of the user collected during enrollment training, or previous authentication sessions, and is stored in one or more user identification data containers, model parameter stores, or other repositories. In some examples, operation 606 involves computing similarity metrics between the current signal features and the stored reference features, such as distances in an embedding space, correlation scores, or classification probabilities. Additionally or alternatively, in some examples, the comparison at operation 606 is performed as part of a model training pipeline, in which reference features are updated over time as new authenticated data is collected.

In some examples, referencing FIG. 6, process 600 continues to operation 608, where the computing system (e.g., computing system 100 as described with respect to FIG. 1) determines an accuracy value based on the comparison performed at operation 606. The accuracy value at operation 608 can, in some examples, correspond to an indication of how closely the current signal features match the stored reference features of the user, and is expressed as a probability, confidence score, or normalized similarity metric. Operation 608 can therefore, in some examples, generate an accuracy value indicative of verification of a user identity. Additionally or alternatively, in some examples, the accuracy value is computed by aggregating multiple comparison results across different sensors or different time intervals, such that a combined accuracy value reflects the overall strength of evidence that the current signal data corresponds to an enrolled user.

In some examples, referencing FIG. 6, process 600 proceeds to operation 610, where the computing system computes an authentication accuracy value based on the accuracy value determined at operation 608. In some examples, operation 610 applies one or more weighting factors, fusion rules, or model outputs to convert the accuracy value into an authentication accuracy value that represents a probability that the user identity corresponds to an authorized user. For example, operation 610 optionally combines separate accuracy values for biometric features and contextual features into a single authentication accuracy value used to drive continuous multi-factor identification and authentication. Additionally or alternatively, in some examples, operation 610 updates a running authentication accuracy value over time as new sensor data is received.

In some examples, referencing FIG. 6, process 600 continues to operation 612, where the computing system infers an event context from the sensor data, the extracted signal features, and/or the authentication accuracy value. The event context at operation 612 can, in some examples, correspond to a characterization of what is occurring during the event (e.g., walking, running, exercising, working at a desk, participating in a video conference, or interacting with a particular application). In some examples, the inference at operation 612 makes use of context data inference models, application usage logs, location data, time-of-day information, or other contextual signals. Additionally or alternatively, in some examples, operation 612 optionally determines context such as the data domain associated with the event (e.g., health and wellness data, legal document access, laboratory data review, or financial transaction monitoring), which is used to select appropriate user data containers or ledgers.

In some examples, referencing FIG. 6, process 600 advances to operation 612, where the computing system computes a label confidence associated with one or more metadata labels to be applied to the event. The label confidence at operation 614 can, in some examples, be based on the inferred event context, the extracted signal features, and the authentication accuracy value, and indicates a probability that a proposed label correctly describes the event. For example, a label optionally indicates that an event corresponds to “accessing financial records,” or “reviewing laboratory test results,” and the label confidence optionally quantifies how strongly the available data supports that label. Additionally or alternatively, in some examples, operation 614 computes label confidence values for multiple candidate labels, and select one or more labels whose label confidence exceeds a label threshold, or rank the labels for downstream selection.

In some examples, referencing FIG. 6, process 600 proceeds to operation 616, wherein the computing system determines whether the label confidence satisfies a label threshold. In some examples, the label threshold at operation 616 is configurable per user, per application, or per data domain, and is adjusted dynamically based on historical performance or risk tolerance. For example, the computing system optionally raises the label threshold when prior labeling incidents show a pattern of false positives or lower the label threshold when historical data indicates consistent high-confidence matches across similar sensor conditions. In some examples, an enterprise-level risk tolerance setting (e.g., high security mode for financial or legal data versus a low-risk mode for wellness analytics) dynamically shifts the label threshold to require stricter or more lenient confidence levels before a label is assigned. Additionally or alternatively, in some examples, different thresholds are used for different types of labels, such that sensitive labels e.g., legal or financial labels) require a higher label confidence than less sensitive labels (e.g., generic activity categories).

In some examples, referencing FIG. 6, when the label confidence satisfies the label threshold (YES at 616), process 600 proceeds to operation 618, wherein the computing system assembles an event record with a label. The event record at operation 618 includes the selected metadata label(s), the label confidence value, the inferred event context, a timestamp, and identifiers of the sensor data and user data container to which the event corresponds. The assembled event record is prepared for storage in a user data container association with a ledger entry, and/or use by downstream models. Additionally or alternatively, in some examples, operation 618 generates an event record formatted as metadata for indexing and search, such that later processes search user data containers based on label, context, or confidence thresholds.

In some examples, referencing FIG. 6, at operation 620, the label confidence is output as part of the event record. Operation 620 optionally provides the label confidence to a user interface, a metadata search engine, a ledger access control component (for example, as described with respect to FIG. 2), or a watermarking engine. For example, a user interface optionally visually indicates label confidence to a user, or a watermarking process optionally embeds label identifiers and confidence values into watermarked content for later verification. Additionally or alternatively, in some examples, operation 620 logs label confidence values for model retraining, accuracy auditing, or adjustment of thresholds over time.

In some examples, referencing FIG. 6, after assembling the event record and outputting the label confidence, process 600 proceeds to operation 622, wherein the computing system determines whether the user is currently authorized. The determination at operation 622 can, in some examples, rely on the authentication accuracy value computed at operation 610, prior authorization decisions, access policy parameters stored in one or more ledgers, or a combination of these factors. Additionally or alternatively, in some examples, operation 622 evaluates both user authentication status and ledger synchronization status to ensure that access decisions align with distributed ledger state before enabling metadata operations.

In some examples, referencing FIG. 6, when the user is currently authorized (YES at 622), process 600 proceeds to operation 624, wherein the computing system allows a metadata search based on the event record and label. For example, operation 624 optionally updates a metadata index associated with one or more user data containers so that the newly labeled event is found in response to a search query. In some examples, a metadata search interface enables a user, an external system, or a third-party application to search for events having particular labels, label confidence thresholds, or event contexts. Additionally or alternatively, in some examples, operation 624 corresponds to enabling downstream operations, such as smart contract based sharing, container level analytics, or watermarking workflows that rely on trustworthy labels and current authorization.

In some examples, referencing FIG. 6, when the user is not currently authorized (NO at 622), process 600 proceeds to operation 626, where the computing system queues the event locally. The queueing at operation 626 can, in some examples, store the event record, sensor data, and intermediate feature data in a secure local buffer or staging area until conditions are met for applying a label, promoting the event to a user data container, or performing metadata searches. For example, queued events are revisited after additional sensor data is collected, after a user re-authenticates, or after ledger synchronization is restored. Additionally or alternatively, in some examples, operation 626 tags queued events with reasons for queueing (e.g., insufficient label confidence, lack of authorization or ledger out of sync) so that the computing system optionally applies different reprocessing strategies, such as requesting additional user input, adjusting thresholds, or performing retraining of the labeling model.

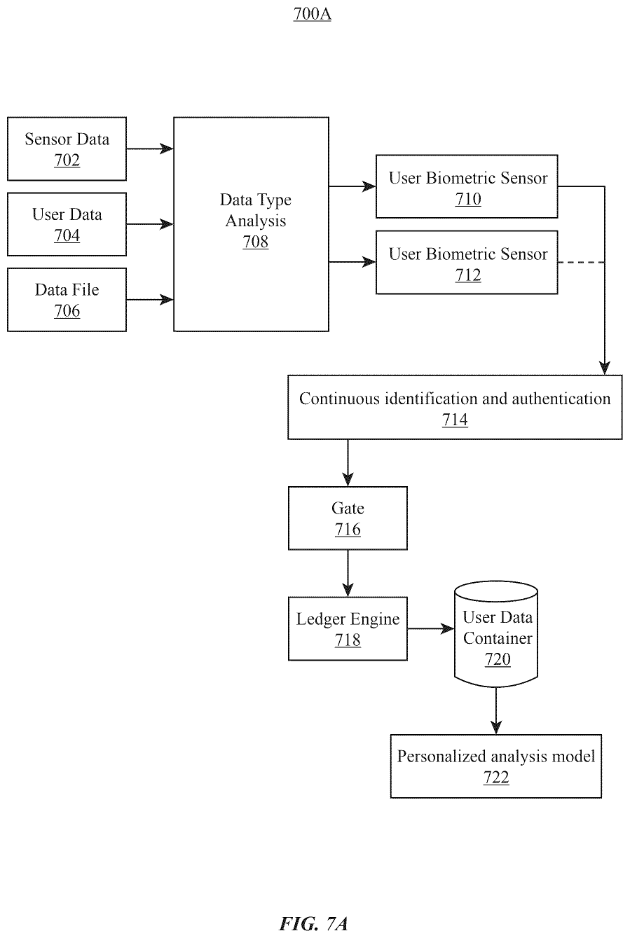

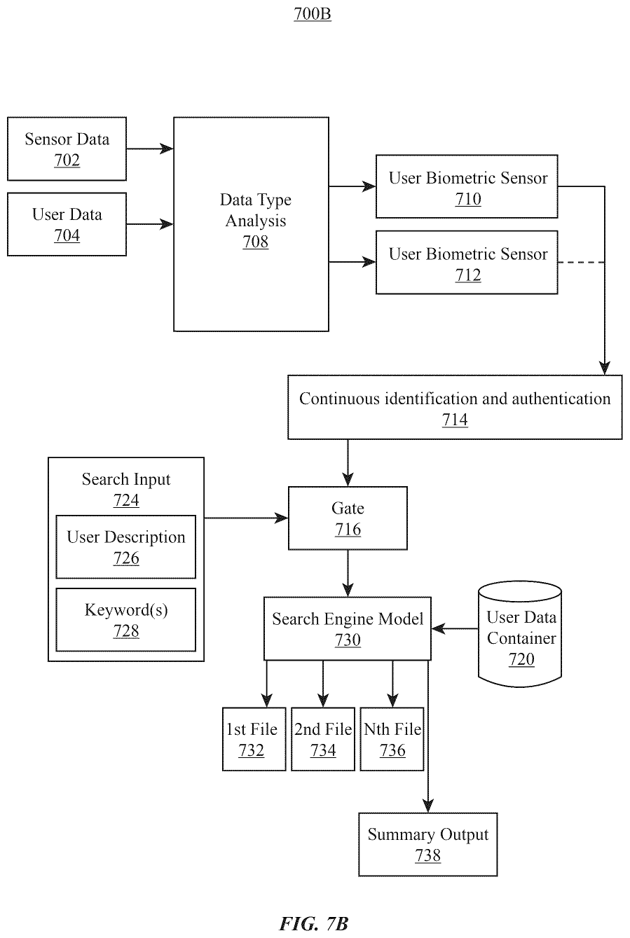

FIG. 7A illustrates an example of a process 700A for applying data type analysis to generate personalized analysis outputs, according to some examples of the disclosure. Authenticating users and/or ledger copies to control access-controlled data such as by analyzing sensor and user data, performing continuous identification and authentication, and selecting or activating a personalized analysis model based on that authenticated access to a user data container improves data privacy, data security, and/or maintains data fidelity by confirming access is authorized and/or limiting the manner in which that potentially sensitive information can be accessed. In some examples, process 700 begins with receiving a plurality of data inputs including sensor data 702, user data 704, and a data file 706. Each of these data inputs optionally originate from distinct sources and optionally correspond to different data domains, in some examples. For example, sensor data 702 optionally includes one or more biometric or contextual data streams such as heart rate signals, motion signatures, muscle activity signals, voice pattern data, ambient light conditions, breath pattern data, environmental temperature, or device orientation data. Additionally or alternatively, in some examples, sensor data 702 is received from a combination of wearable devices, mobile devices, environmental sensors, or remote peripherals communicating over a network.

In some examples, referencing FIG. 7A, the user data 704 represents previously stored or user-provided information such as identity attributes, historical behavioral profiles, prior authentication events, metadata associated with stored files, or contextual labels generated during earlier processing cycles. Additionally or alternatively, in some examples, the user data 704 includes previously generated container metadata such as data type identifiers, collection timestamps, or source identifiers.

In some examples, referencing FIG. 7A, the data file 706 includes one or more files provided by the user, generated by applications, or obtained from external systems. Such files includes laboratory results, legal documents, financial statements, images, audio recordings, portable data objects, or generic binary files. Additionally or alternatively, in some examples, the data file 706 may include encrypted data that has been converted into a non-duplicative object.

In some examples, referencing FIG. 7A, the data inputs (e.g., sensor data 702, user data 704, and data file 706) are provided to and undergo a data type analysis 708, which identifies, classifies, and routes incoming data according to its type, content, format, or data domain characteristics. In some examples, the data type analysis 708 applies one or more inference models that detect whether incoming data corresponds to biometric signals, contextual indicators, application-generated data, or user-provided files. Additionally or alternatively, in some examples, data type analysis 708 includes processing such as format recognition, metadata extraction, file type fingerprinting, or sensor signal deconstruction. For example, the data type analysis 708 optionally determines that data corresponds to a heart rate stream from a wrist-mounted wearable device, a contextual data file for a laboratory test, or a user-generated image. After classifying the input data, the data type analysis 708 can, in some examples, direct the appropriate outputs to one or more biometric sensors or sensor interfaces.

In some examples, referencing FIG. 7A, the output from the data type analysis 708 is provided to a first user biometric sensor 710 and, optionally, to a second user biometric sensor 712. For example, the first user biometric sensor 710 optionally corresponds to data originating from a wrist-mounted photoplethysmography sensor, while the second user biometric sensor 712 optionally corresponds to data from a head-mounted proximity or motion sensor. Additionally or alternatively, in some examples, the first user biometric sensor 710 and, optionally, the second user biometric sensor 712, represents contextual or auxiliary biometric sensors such as posture sensors, environmental microphones, or optical sensors. In some examples, the first user biometric sensor 710 and second user biometric sensor 712 optionally operates individually, cooperatively, or redundantly to provide data for downstream identification and authentication processes. In some examples, the computing system (e.g., computing system 100 as described with respect to FIG. 1) selectively uses one or more sensors depending on model selection, user behavior, or signal quality.

In some examples, referencing FIG. 7A, data output from the first user biometric sensor 710 and, optionally, the second user biometric sensor 712, is provided to a continuous identification and authentication module 714, which evaluates the incoming biometric and contextual data to verify an identity of a user on an ongoing basis. The continuous identification and authentication module 714 can, in some examples, compare extracted signal features against previously stored reference features of the user to generate an authentication accuracy value. Additionally or alternatively, in some examples, the continuous identification and authentication module 714 combines biometric sensor data and contextual sensor data to produce a more robust identity determination that accounts for environmental conditions, device placement, and user-specific behavioral characteristics. In some examples, the continuous identification and authentication module 714 continuously updates the authentication accuracy value in real time, allowing the computing system to detect changes, anomalies, or drops in confidence that optionally indicate potential misuse, a change in sensor position, or that the user has transitioned into a different behavioral context. In some examples, the continuous identification and authentication module 714 cooperates with a watermarking subsystem to embed user-identifying characteristics into data files or outputs in a manner that is imperceptible to the user and which can later be used to verify authenticity and provenance.

In some examples, referencing FIG. 7A, following computation of the authentication accuracy value, process flow advances to gate 716, which operates as a policy enforcement checkpoint. In some examples, gate 716 evaluates whether the authentication accuracy value satisfies at least one predefined threshold required for accessing protected user data. Gate 716 can additionally or alternatively incorporate access policy parameters stored in one or more ledgers, which includes policy conditions such as the type of data being accessed, the domain of the request (e.g., health, legal, financial), a sensitivity level of the requested container, or a requirement to meet stricter confidence thresholds for specific operations. In some examples, gate 716 further examines conditions associated with smart contract enforcement rules that govern data sharing permissions, read-only or write-restricted access, duration limits, and synchronization requirements between multiple ledger copies. In some examples, if the gate 716 determines that the authentication accuracy value or applicable policy conditions are not satisfied, the process optionally halts, requires user re-authentication, or triggers a secondary action such as session teardown or a prompt requesting additional user confirmation.

In some examples, referencing FIG. 7A, when the gate 716 determines that the applicable threshold and policy conditions are satisfied, control passes to ledger engine 718, which verifies and enforces ledger-based authorization requirements. In some examples, the ledger engine 718 confirms that the accessing device's local ledger copy is synchronized with a distributed ledger network to ensure that container integrity and access histories remain consistent across all participating nodes. If synchronization is verified, the ledger engine 718 in some examples, authorizes access, generates a new immutable record within the ledger, and applies a timestamp, cryptographic hash, or additional metadata describing the access event. Additionally or alternatively, in some examples, the ledger engine 718 manages external user authorization flows, such as cases in which a designated secondary user temporarily authenticates on behalf of the primary user when the primary user's authentication is unavailable, uncharged, or otherwise unable to complete the authentication process. In some examples, if the ledger engine 718 determines that the ledger is out of sync, or if one or more smart contract conditions are unmet, the computing system optionally denies or revokes access and records the attempted access as an event within the ledger, in accordance with operations 514 and 516 described with respect to FIG. 5.

In some examples, referencing FIG. 7A, upon successful authorization by the ledger engine 718, the process advances to user data container 720, which optionally stores a wide range of user-specific information across multiple data domains. In some examples, the user data container 720 includes identification data, health and wellness data, laboratory results, legal documents, financial records, contextual sensor data, and metadata labels or label-confidence analytics. Additionally or alternatively, in some examples, the user data container 720 stores encrypted files, unique or non-duplicative data objects, containers segmented by data domain, or metadata linking container contents across multiple ledgers. In some examples, the user data container 720 functions as a centralized and secure repository for user information that is accessed, analyzed, and shared subject to authentication, ledger policy enforcement, and smart contract rules.

In some examples, referencing FIG. 7A, outputs from the user data container 720 are provided to a personalized analysis model 722, which applies individualized models or inference processes to generate user-specific insights. For example, the personalized analysis model 722 optionally analyzes biometric patterns, historical data, contextual metadata, health and wellness indicators, legal activity, financial trends, or user-generated content to produce tailored recommendations or predictions. Additionally or alternatively, in some examples, the personalized analysis model 722 performs identity confidence analytics, detects behavioral anomalies, evaluates data watermark integrity, or generates summaries used in metadata search interfaces. In some examples, the personalized analysis model 722 operates in real time, intermittently, or upon request, and optionally leverages newly ingested data, previously stored data, or both, to refine user-specific outputs.

In some examples, the computing system enables remote authentication for automated personal devices such as robotic vacuums, HVAC systems, or other networked appliances. For example, when a user authenticates using the CMFIA protocol, the user optionally interacts with these devices either directly through a platform computing device or indirectly through another authenticated device associated with the organization. In some examples, the user defines or edits schedules for automated tasks, reviews status summaries, or receives device-generated notifications reporting performance or errors.

FIG. 7B illustrates an example of a process 700B for performing an authenticated search of user-specific data stored in one or more user data containers, according to some examples of the disclosure. Authenticating users and/or ledger copies to control access-controlled data such as by gating search inputs through an authentication access gate, executing a search engine model over user data containers, and generating a summary output from authenticated metadata improves data privacy, data security, and/or maintains data fidelity by confirming access is authorized and/or limiting the manner in which that potentially sensitive information can be accessed. In some examples, data type analysis 708 involves classifying the incoming information according to semantic category, hierarchical metadata class, or sensitivity level to ensure that subsequent search operations are performed under appropriate access controls. In some examples, a search input 724 is received, which includes at least one of a user description 726, one or more keyword(s) 728, or a combination thereof.

In some examples, referencing FIG. 7B, user description 726 includes natural language descriptions paraphrased content summaries, contextual constraints (e.g., location-based qualifiers or data range filters), or user-provided clarifications specifying desired file types, such as laboratory data, audio recordings, health tracking graphs, financial ledger exports, or identification documents. Additionally or alternatively, in some examples, keyword(s) 728 includes inferred query terms suggested by the computing system (e.g., computing system 100 as described with respect to FIG. 1) based on the user's query history, sensor-based behavioral indicators, or metadata previously associated with files in the user data container 720. In some examples, the search input 724 is then passed to gate 716, which evaluates the authentication state produced by continuous identification and authentication module 714, and the search parameters provided by the user. In some examples, the gate 716 enforces query-level policy controls, such as restrictions preventing certain search terms from being executed unless the authentication accuracy value exceeds a heightened threshold, or unless the requested data category is permitted under an active smart contract based access policy. Additionally or alternatively, in some examples, the gate 716 requires a match between a search term and an authorized metadata field before authorizing the search.

Upon successful authentication, referencing FIG. 7B, the gate 716 can, in some examples, provide access to a search engine model 730, which performs a secure retrieval operation using the content stored in the user data container 720. In some examples, the search engine model 730 outputs one or more matching files, such as a first file 732, second file 734, and n-th file 736. Additionally or alternatively, in some examples, the search engine model 730 generates intermediate candidate file lists, confidence weighted scoring tables, or structured summaries describing how each matched file relates to the search input 724. In some examples, the matched files are then used to produce a summary output 738. In some examples, the search engine model 730 employs domain-specific retrieval logic depending on the type of file being queried. For example, the search engine model 730 optionally prioritizes files based on temporal proximity when handling health-related data, apply hierarchical indexing structures to retrieve legal or financial documents, or recognize contextual pairings between sensor-event logs and their corresponding metadata. In some examples, the search engine model 730 ranks files according to their relevance scores, similarity metrics, contextual associations, or user-preference histories. In some examples, the search engine model 730 filters out files whose metadata or sensitivity levels indicate that heightened authentication would be required before release.

In some examples, referencing FIG. 7B, the output of the retrieval process is used to generate a summary output 738, which presents an automatically generated narrative explanation of the retrieved results, a condensed description of the content of each matched file, or a combination thereof. Additionally or alternatively, in some examples, summary output 738 includes structured metadata fields extracted from matched files, listings of the contextual factors that led to each match, or rank-ordered indications of the correspondence between search terms and file attributes. In some examples, the summary output 738 is produced in a form suitable for immediate user review, cached locally, or encrypted for reinsertion into the user data container 720 so that the summary itself becomes part of the user's searchable data history. Additionally or alternatively, in some examples, the summary output 738 is transformed into a reduced sensitivity version for situations in which an external user or third party application holds conditional access rights.

In some examples, once a user is authenticated, the computing system enables the user to install or configure third-party applications on devices associated with the platforms. In some examples, such third-party applications obtain access to one or more containers by executing within an isolated third-party software container. If appropriately authorized, the application optionally accesses health, identification, contextual, or behavioral data stored in the container and performs software-defined analyses. In some examples, the resulting analysis output is written to the corresponding data container and recorded into the ledger. Additionally or alternatively, in some examples, a third-party application executes on a cloud server or external computing platform. The platform computing device optionally transmits notifications to the external system when new container data becomes available. In some examples, the external system performs its designated computation and returns results to the platform computing device, where such results are added to the appropriate containers and recorded on the relevant ledger copies.

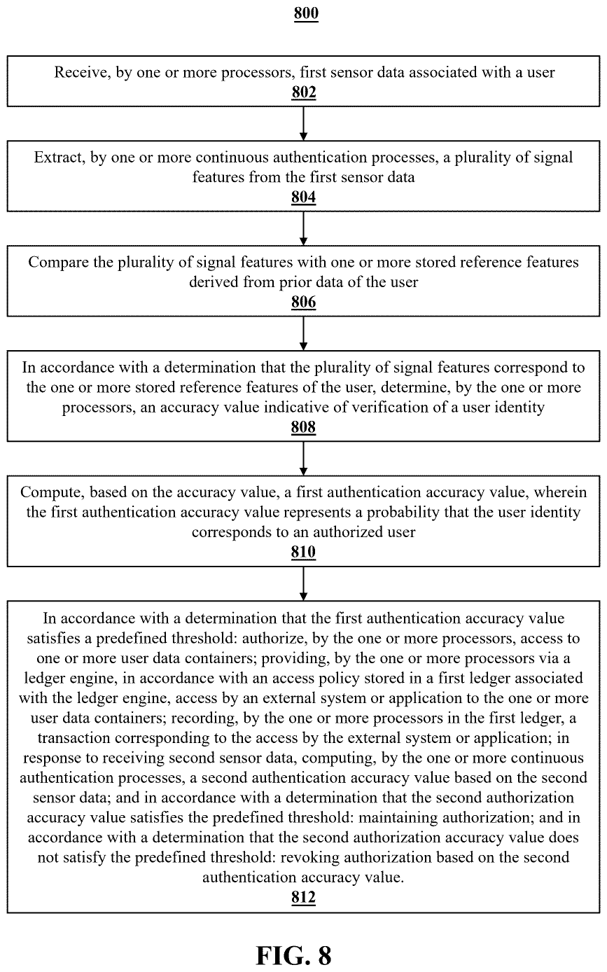

FIG. 8 illustrates an example of a process 800 for continuously identifying and authenticating a user to authorize access to one or more user data containers, according to some examples of the disclosure. Authenticating users and/or ledger copies to control access-controlled data such as by generating signal features, computing authentication accuracy values, authorizing or revoking access based on a predefined threshold, and recording the transaction in a distributed ledger improves data privacy, data security, and/or maintains data fidelity by confirming access is authorized and/or limiting the manner in which that potentially sensitive information can be accessed. In some examples, process 800 begins by receiving, by one or more processors, first sensor data associated with a user at operation 802. In some examples, the first sensor data includes biometric signals such as heart rate data, motion signatures, muscle activity signals, voice pattern data, or combinations thereof. Additionally or alternatively, in some examples, the first sensor data comprises non-biometric or contextual information such as location information, environmental readings, device orientation, or network connectivity status. In some examples, the first sensor data includes data obtained during a model-training phase. Additionally or alternatively, in some examples, the first sensor data is received directly from one or more sensors, or indirectly via the one or more processors, interfaces, device drivers, acquisition circuitry, or other local or remote modules.

In some examples, referencing FIG. 8, at operation 804, the computing system (e.g., computing system 100 as described with respect to FIG. 1) extracts, by one or more continuous authentication processes, a plurality of signal features from the first sensor data. In some examples, the extracted signal features include frequency-domain features, temporal signatures, statistical distributions, motion-based patterns, or device-state indicators derived or extracted from the sensor data. Additionally or alternatively, in some examples, signal features are extracted using machine-learning models trained on previously collected user data. In some examples, signal features are extracted using lightweight signal processing techniques suitable for local or on-device computation.

In some examples, referencing FIG. 8, at operation 806, the computing system compares the plurality of extracted signal features with one or more stored reference features extracted from prior data of the user. In some examples, the reference features are generated during an enrollment phase and stored in an encrypted format within a user-specific data container. Additionally or alternatively, in some examples, the stored reference features include contextual patterns such as typical movement behavior, characteristics environmental cues, or user-specific physiological baselines. In some examples, the comparison is performed using nearest-neighbor analysis, statistical correlation, or multi-factor comparison algorithms capable of fusing biometric and contextual inputs.

In some examples, referencing FIG. 8, at operation 808, in accordance with a determination that the plurality of signal features correspond to the one or more stored reference features of the user, the computing system determines, by the one or more processors, an accuracy value indicative of verification of a user identity. In some examples, the accuracy value represents a numerical probability that the current sensor data corresponds to the authorized user, a confidence metric computed by a trained model, or a composite verification score combining biometric, contextual, and historical attributes. In some examples, the accuracy value incorporates time-based or risk-based weighting, such that deviations from expected patterns during unusual user contexts result in lower confidence values.

In some examples, referencing FIG. 8, at operation 810, the computing system computes, based on the accuracy value, a first authentication accuracy value, wherein the first authentication accuracy value represents a probability that the user identity corresponds to an authorized user. In some examples, the authentication accuracy value is aggregated across multiple sensor channels. For example, a combination of heart rate derived features and motion features optionally increase confidence, whereas conflicting signals can, in some examples, decrease it. Additionally or alternatively, in some examples, the computing system employs contextual inference models to modify the first authentication accuracy value based on current environmental, behavioral, or device-use context.

In some examples, referencing FIG. 8, at operation 812, the computing system performs a multi-step conditional access and ledger-recording workflow. In some examples, in accordance with a determination that the first authentication accuracy value satisfies a predefined threshold, the computing system authorizes, by the one or more processors, access to one or more user data containers. In some examples, secondary actions include session teardown, container lockout, or user prompts for re-authentication. The computing system then provides, by the one or more processors via a ledger engine, in accordance with an access policy stored in a first ledger associated with the ledger engine, access by an external system or application to the one or more user data containers. In some examples, the access policy is embodied as a smart contract that automatically enforces sharing terms, access durations, synchronization conditions, permission levels, and revocation triggers. As used herein, the actions performed at operation 812 are optionally performed in different orders, in overlapping time windows, or independently of whether any of the other actions are performed. For example, the computing system optionally records a ledger transaction even when secondary authentication is not requested, or optionally performs secondary authentication computations without triggering any access-provision step.

In some examples, referencing FIG. 8, the computing system then records, by the one or more processors in the first ledger, a transaction corresponding to the access by the external system or application. In some examples, in response to receiving second sensor data, the computing system then computes, by the one or more continuous authentication processes, a second authentication accuracy value based on the second sensor data. In some examples, the second authentication accuracy value provides ongoing verification during an active session. In some examples, in accordance with a determination that the second authorization accuracy value satisfies the predefined threshold: the computing system maintains authorization. Additionally or alternatively, in some examples, in accordance with a determination that the second authorization accuracy value does not satisfy the predefined threshold, the computing system revokes authorization based on the second authentication accuracy value. In some examples, revocation triggers secondary security measures such as logging an anomalous event, suspending the session, or disabling container access until re-authentication occurs. Additionally or alternatively, in some examples, revocation initiates external user backup authentication.

In some examples, the computing system supports dependent authentication relationships in which authentication of one user or device is conditional on the approval of another user. In some examples, when an active user adds another user to the organization, the active user designates that the second user's authentication or identification requires confirmation from the active user. When the dependent user attempts to authenticate, the computing system optionally transmits a notification to devices associated with the active user. In some examples, if the active user approves the request, the dependent user is authenticated; otherwise, authentication is denied. Additionally or alternatively, in some examples, dependent authentication is restricted to specific tasks such as point-of-service payment authorization performed by third-party applications integrated into the organizational container architecture.

It is understood that process 800 is an example and that more, fewer, or different operations can be performed in the same or in a different order. Additionally, the operations in process 900 described above are, optionally, implemented by running one or more functional modules in an information processing apparatus such as general-purpose processors (e.g., as described with respect to FIG. 1) or application specific chips, and/or by other components of FIG. 1.

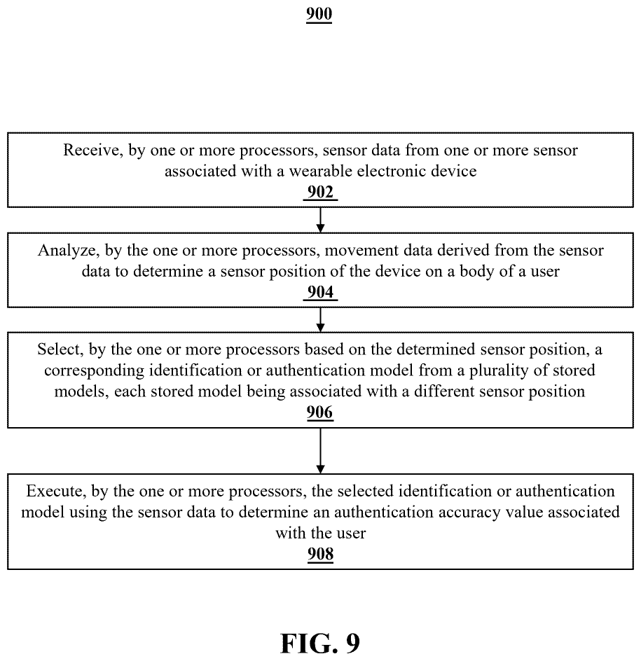

FIG. 9 illustrates an example of a process 900 for continuously identifying and authenticating a user to authorize access to one or more user data containers, according to some examples of the disclosure. Authenticating users and/or ledger copies to control access-controlled data such as by determining a wearable device's sensor position on a user and selecting a corresponding identification or authentication model based on that position improves data privacy, data security, and/or maintains data fidelity by confirming access is authorized and/or limiting the manner in which that potentially sensitive information can be accessed. In some examples, at operation 902, one or more processors receive sensor data from one or more sensors associated with a wearable electronic device. In some examples, the wearable electronic device comprises a wrist-worn device, an ear-mounted device, an ankle-worn sensor band, or another form factor capable of collecting physiological or contextual signals. Additionally or alternatively, in some examples, the sensor data includes accelerometer streams, gyroscope data, electromyographic (EMG) activity, pressure signals, or any other movement-indicative or position-indicative measurements generated by the device while being worn on different regions of a user's body.

In some examples, referencing FIG. 9, at operation 904, the computing system (e.g., computing system 100 as described with respect to FIG. 1) analyzes movement derived or extracted from the sensor data to determine a sensor position of the device on the body of the user. Additionally or alternatively, in some examples, the computing system determines that the wearable electronic device is on the user's wrist based on characteristic wrist-rotation signatures, repetitive gait oscillations, or micro motions associated with hand movements. In some examples, the computing system determines that the wearable electronic device is worn on the user's ankle based on cyclic stride accelerometer signatures or, for example, on the user's torso based on respiration-related expansion patterns.

In some examples, referencing FIG. 9, at operation 906, based on the determined sensor position, the computing system optionally selects a corresponding identification or authentication model from a plurality of stored models, with each stored model being associated with a different sensor position. For example, a wrist-based model optionally uses heart rate variability, pulse waveform characteristics, and wrist motion derived patterns as primary indicators for identity verification. In some examples, an ankle-based model prioritizes gait-signature recognition and step cadence patterns, whereas a torso-mounted model may utilize breathing profiles or upper-body motion signatures.

In some examples, referencing FIG. 9, at operation 908, the computing system executes, by the one or more processors, the selected identification or authentication model using the sensor data to determine an authentication accuracy value associated with the user. In some examples, the authentication accuracy value represents a confidence score associated with whether the measured sensor features match those expected from the user at that particular sensor position. Additionally or alternatively, in some examples, the authentication accuracy value incorporates contextual factors, risk-based adjustments, or time-based weighting to ensure robust identity verification even when the wearable electronic device is moved or repositioned.

It is understood that process 900 is an example and that more, fewer, or different operations can be performed in the same or in a different order. Additionally, the operations in process 900 described above are, optionally, implemented by running one or more functional modules in an information processing apparatus such as general-purpose processors (e.g., as described with respect to FIG. 1) or application specific chips, and/or by other components of FIG. 1.

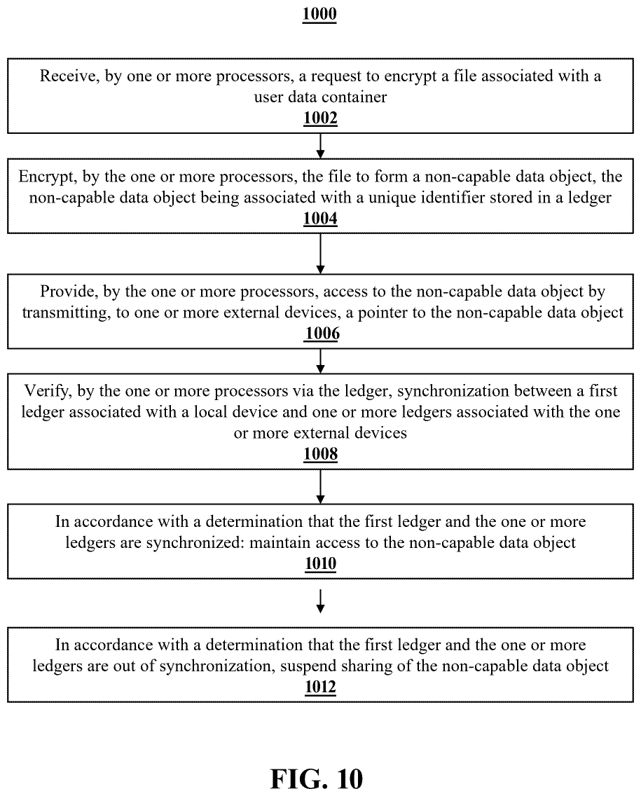

FIG. 10 illustrates an example of a process 1000 for continuously identifying and authenticating a user to authorize access to one or more user data containers, according to some examples of the disclosure. Authenticating users and/or ledger copies to control access-controlled data such as by encrypting a file into a non-capable data object, transmitting a pointer to the non-capable data object to external systems, and maintaining or suspending access based on ledger synchronization status improves data privacy, data security, and/or maintains data fidelity by confirming access is authorized and/or limiting the manner in which that potentially sensitive information can be accessed. In some examples, at operation 1002, the computing system, by the one or more processors, receives a request to encrypt a file associated with a user data container. In some examples, the file includes biometric records, laboratory test results, financial statements, identification materials, or any other sensitive information stored within the user data container. Additionally or alternatively, in some examples, the request is generated automatically in response to detecting a new file entering the user data container, or in response to a system policy requiring encryption before any sharing event is permitted.

In some examples, referencing FIG. 10, at operation 1004, the computing system, by the one or more processors, encrypts the file to form a non-capable data object, wherein the encrypted object is associated with a unique identifier stored in a ledger. In some examples, the unique identifier, such as a cryptographic hash, a content-derived signature, or a ledger-assigned object ID, ensures that all references to the encrypted file resolve back to the same single canonical version to prevent accidental duplication, version drift, or tampering.

In some examples, referencing FIG. 10, at operation 1006, the computing system, by the one or more processors, provides access to the non-capable data object by transmitting, to one or more external devices, a pointer to the non-capable data object. For example, an external researcher, healthcare provider, legal representative, or smart contract driven machine process optionally receives a pointer directing them to the correct encrypted object without obtaining a standalone copy of the object itself. In some examples, the pointer is a ledger reference, a hash-based locator, or a secure token that resolves through the ledger engine to the canonical encrypted file.

In some examples, referencing FIG. 10, at operation 1008, the computing system, by the one or more processors, verifies, via the ledger, synchronization between a first ledger associated with a local device and one or more ledgers associated with the external devices receiving the pointer. In some examples, synchronization verification includes comparing ledger block heights timestamps, hash values, or transaction histories. Additionally or alternatively, in some examples, the computing system (e.g., computing system 100 as described with respect to FIG. 1) optionally requires a threshold level of consensus across the distributed ledger network before permitting continued access to the encrypted object.

In some examples, referencing FIG. 10, at operation 1010, in accordance with a determination that the first ledger and the one or more external ledgers are synchronized, the computing system maintains access to the non-capable data object. In some examples, maintaining access includes allowing external devices to follow the pointer to retrieve authorized portions of the encrypted object, process the object using predefined capabilities, or enforce smart contract based access terms defined by an access policy.

In some examples, referencing FIG. 10, at operation 1012, in accordance with a determination that the first ledger and the one or more external ledgers are out of synchronization, the computing system suspends sharing of the non-capable data object. Suspending sharing includes revoking pointer validity, preventing resolution of the pointer via the ledger engine, delaying outgoing data requests, or temporarily blocking external devices from interacting with the encrypted object. In some examples, sharing is suspended until all external devices rejoin the consensus state, their local ledger copies reconcile with the trusted ledger copy, or the computing system determines that no tampering or rollback attempts are underway.

In some examples, the computing system supports sharing data from a container with an external individual, group, or entity that is not part of the organization. In some examples, the sharing action is recorded only in the active user's ledger and does not result in a multi-party shared ledger for that particular interaction. In some examples, the enrolled user transmits a QR code, link, or similar identifier that directs the external recipient to install a viewing application or access a controlled cloud-based reader. In some examples, the external recipient views the shared data within a restricted access environment governed by time-limited or view-only policies defined by the active user. Additionally or alternatively, in some examples, the viewing application prevents copying, downloading, or further redistribution of the shared data.

It is understood that process 1000 is an example and that more, fewer, or different operations can be performed in the same or in a different order. Additionally, the operations in process 1000 described above are, optionally, implemented by running one or more functional modules in an information processing apparatus such as general-purpose processors (e.g., as described with respect to FIG. 1) or application specific chips, and/or by other components of FIG. 1.

Therefore, according to the above, some examples of the disclosure are directed to a method, performed by a computing system wherein the computing system receives, by one or more processors, first sensor data associated with a user. In some examples the computing system extracts, by one or more continuous authentication processes, a plurality of signal features from the first sensor data. In some examples, the computing system compares the plurality of signal features with one or more stored reference features extracted from prior data of the user. In some examples, in accordance with a determination that the plurality of signal features correspond to the one or more stored reference features of the user, the computing system determines, by the one or more processors, an accuracy value indicative of verification of a user identity. In some examples, the computing system computes, based on the accuracy value, a first authentication accuracy value, wherein the first authentication accuracy value represents a probability that the user identity corresponds to an authorized user. In some examples, in accordance with a determination that the first authentication accuracy value satisfies a predefined threshold, the computing system authorizes, by the one or more processors, access to one or more user data containers. In some examples, the computing system enables, by the one or more processors via a ledger engine, in accordance with an access policy stored in a first ledger associated with the ledger engine, an external computing system to access the one or more user data containers. In some examples, the computing system records, by the one or more processors in the first ledger, a cryptographically verifiable transaction corresponding to the access by the external system or application. In some examples, in response to receiving second sensor data, the computing system computes, by the one or more continuous authentication processes, a second authentication accuracy value based on the second sensor data. In some examples, in accordance with a determination that the second authentication accuracy value satisfies the predefined threshold, the computing system maintains authorization. In some examples, in accordance with a determination that the second authentication accuracy value does not satisfy the predefined threshold, the computing system revokes authorization.

Additionally or alternatively to one or more of the examples disclosed above, in some examples, the first sensor data comprises at least one of heart rate data, motion data, muscle activity data, facial feature data, breath pattern data or voice pattern data. Additionally or alternatively to one or more of the examples disclosed above, in some examples, the first sensor data comprises at least one of location data, ambient light data, environmental temperature data, device orientation data, or network connectivity data. Additionally or alternatively to one or more of the examples disclosed above, in some examples, the ledger engine is configured to record the transaction with a timestamp and a cryptographic hash derived or extracted from at least a portion of the first sensor data or at least a portion of the second sensor data. Additionally or alternatively to one or more of the examples disclosed above, in some examples, the second ledger copy is stored locally on a device associated with the user, and verifying synchronization further comprises periodically comparing at least one entry of the second ledger copy with at least one entry of the distributed ledger network.

Additionally or alternatively to one or more of the examples disclosed above, in some examples, the plurality of signal features further comprise at least one of a motion signature, physiological parameter, positional pattern, or device-state indicator derived or extracted from at least one of the first sensor data and/or the second sensor data. Additionally or alternatively to one or more of the examples disclosed above, in some examples, the one or more user data containers further comprise metadata defining at least one of a data type identifier, a collection timestamp, a sensor source identifier, a data accuracy score, or a contextual tag associated with the data type identifier. Additionally or alternatively to one or more of the examples disclosed above, in some examples, the method further comprises enabling, by the computing system, via the one or more processors, a metadata search interface that receives a user-provided description or keyword corresponding to the metadata of the one or more user data containers. Additionally or alternatively to one or more of the examples disclosed above, in some examples, the method further comprises, in response to performing a search of the metadata, generating, by the computing system, via the one or more processors, a summary output identifying one or more of the user data containers that match a query corresponding to the metadata, wherein the summary output is derived or generated from analysis of the metadata stored in the one or more user data containers.

Additionally or alternatively to one or more of the examples disclosed above, in some examples, the one or more user data containers are associated with one or more metadata records linking the one or more user data containers to multiple ledgers corresponding to different data domains. Additionally or alternatively to one or more of the examples disclosed above, in some examples, the one or more user data containers are interoperable across multiple data domains, including at least one of healthcare, legal, financial, or personal data ledgers. Additionally or alternatively to one or more of the examples disclosed above, in some examples, the method further comprises generating, by computing system, via the one or more processors, an alert or triggering a secondary action when the first authentication accuracy value satisfies a predefined threshold. Additionally or alternatively to one or more of the examples disclosed above, in some examples, the method further comprises generating, by the computing system, via the one or more processors, metadata labels for the first sensor data, the metadata labels comprising at least one of a data type identifier, contextual category, or source identifier, wherein the metadata labels are generated without user input based on analysis of one or more characteristics of the first sensor data and/or the second sensor data.

Additionally or alternatively to one or more of the examples disclosed above, in some examples, the first sensor data comprises biometric sensor data and contextual sensor data, and wherein the one or more continuous authentication processes combine a plurality of signal features extracted from each of the biometric sensor data and the contextual sensor data to determine the accuracy value. Additionally or alternatively to one or more of the examples disclosed above, in some examples, comparison of the plurality of signal features with one or more stored reference features is performed during model training to generate a user-specific reference model prior to deployment. Additionally or alternatively to one or more of the examples disclosed above, in some examples, in accordance with and/or in response to a determination that the authentication accuracy value does not satisfy a predefined threshold, generating a secondary action, wherein the secondary action comprises at least one of a session teardown, container lockout, or user prompt for re-authentication.

Additionally or alternatively to one or more of the examples disclosed above, in some examples, the ledger comprises a blockchain-based distributed ledger network. Additionally or alternatively to one or more of the examples disclosed above, in some examples, the access policy is implemented as a smart contract configured to automatically enforce at least one data sharing term and at least one synchronization event among one or more authorized users. Additionally or alternatively to one or more of the examples disclosed above, in some examples, the method further comprises prompting, by the computing system, via the one or more processors, the user to define one or more access parameters including at least one of a duration, permission level, or sharing authorization or an external user. Additionally or alternatively to one or more of the examples disclosed above, in some examples, the permission level comprises at least one of a read-only, write-only, or read-write access level. Additionally or alternatively to one or more of the examples disclosed above, in some examples, the method further comprises enabling, by the computing system, via the one or more processors, the user to specify an external user to gain access to the one or more user data containers for a defined duration. Additionally or alternatively to one or more of the examples disclosed above, in some examples, the method further comprises enabling, by the computing system, via the one or more processors, a third party application to access the one or more user data containers through at least one of a smart contract or an application programming interface (API).

Some examples of the disclosure are directed to an electronic device, comprising: one or more processors; memory; and one or more programs stored in the memory and configured to be executed by the computing system, via the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings including combination of one or more operations and/or methods described in relation to process 300, 500, 600, 700, 800, 900, and/or 1000. The examples were chosen and described in order to best explain the principles of the disclosure and its practical applications, to thereby enable others skilled in the art to best use the disclosure and various described examples with various modifications as are suited to the particular use contemplated.

The present disclosure acknowledges that, in certain instances, the data employed optionally encompasses personal information that can uniquely identify or be used to contact or locate an individual. Such personal information includes demographic details, content consumption activities, location data, phone numbers, email addresses, Twitter IDs, home addresses, health or fitness-related records (e.g., vital signs, medication details, exercise information), date of birth, or any other identifying or personal information. Specifically, as detailed herein, one aspect of the present disclosure involves tracking a user's biometric data.

The present disclosure recognizes that utilizing such personal information data within the current technology can be advantageous for users. For instance, personal information data can be used to display suggested text that dynamically updates based on changes in a user's biometric data. For example, the suggested text optionally adjusts in response to alterations in the user's age, height, weight, and/or health history.

The present disclosure anticipates that entities responsible for the collection, analysis, disclosure, transfer, storage, or other utilization of such personal information data will adhere to established privacy policies and practices. Specifically, these entities should implement and consistently follow privacy policies and practices that are widely regarded as meeting or exceeding industry or governmental standards for keeping personal information data private and secure. Such policies should be readily accessible to users and updated as the collection and/or use of data evolves. Personal information from users should be gathered for legitimate and reasonable purposes of the entity and not shared or sold beyond those legitimate uses. Furthermore, such collection and sharing should occur only after obtaining informed consent from the users. Additionally, these entities should take necessary measures to safeguard and secure access to such personal information data and ensure that others with access to the data adhere to their privacy policies and procedures. Furthermore, these entities optionally undergo third-party evaluations to certify their compliance with widely accepted privacy policies and practices. Additionally, policies and practices should be tailored to the specific types of personal information data being collected and/or accessed and adapted to applicable laws and standards, including jurisdiction-specific considerations. For example, in the United States, the collection of or access to certain health data is governed by federal and/or state laws such as the Health Insurance Portability and Accountability Act (HIPAA), whereas health data in other countries is subject to different regulations and policies and should be managed accordingly. Thus, different privacy practices should be maintained for various personal data types in each country.

Notwithstanding the above, the present disclosure also contemplates scenarios where users selectively block the use of or access to personal information data. That is, the present disclosure envisions that hardware and/or software components can be provided to prevent or restrict access to such personal information data. For example, the present technology can be configured to allow users to opt in or opt out of the collection of personal information data during service registration or at any time thereafter. In another instance, users optionally choose not to enable the recording of personal information data in a specific application (e.g., a first application and/or a second application). In addition to providing opt-in and opt-out options, the present disclosure envisions offering notifications related to the access or use of personal information. For instance, a user can be notified upon the initiation of collection that their personal information data will be accessed and then reminded again just before the data is accessed by one or more devices.

Moreover, it is the intent of the present disclosure that personal information data should be managed and handled in a manner that minimizes the risks of unintentional or unauthorized access or use. Risk can be mitigated by limiting data collection and deleting data once it is no longer needed. Additionally, and where applicable, including in certain health-related applications, data de-identification can be employed to protect a user's privacy. De-identification can be facilitated, when appropriate, by removing specific identifiers (e.g., date of birth), controlling the amount or specificity of data stored (e.g., collecting location data at a city level rather than at an address level), managing how data is stored (e.g., aggregating data across users), and/or other methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A computer-implemented method, comprising:
receiving, by one or more processors, first sensor data associated with a user;
extracting, by one or more continuous authentication processes, a plurality of signal features from the first sensor data;
comparing the plurality of signal features with one or more stored reference features derived from prior data of the user;
in accordance with a determination that the plurality of signal features correspond to the one or more stored reference features of the user, determining, by the one or more processors, an accuracy value indicative of verification of a user identity;
computing, based on the accuracy value, a first authentication accuracy value, wherein the first authentication accuracy value represents a probability that the user identity corresponds to an authorized user; and
in accordance with a determination that the first authentication accuracy value satisfies a predefined threshold:
authorizing, by the one or more processors, access to one or more user data containers;
enabling, by the one or more processors via a first ledger engine, in accordance with an access policy stored in a first ledger associated with the first ledger engine, an external computing system to access the one or more user data containers;
recording, by the one or more processors in the first ledger, a cryptographically verifiable transaction corresponding to the access by the external computing system;
in response to receiving second sensor data, computing, by the one or more continuous authentication processes, a second authentication accuracy value based on the second sensor data; and
in accordance with a determination that the second authentication accuracy value satisfies the predefined threshold:
maintaining authorization; and
in accordance with a determination that the second authentication accuracy value does not satisfy the predefined threshold:
revoking authorization.

2. The computer-implemented method of claim 1, wherein the first sensor data comprises at least one of heart rate data, motion data, muscle activity data, facial feature data, or voice pattern data.

3. The computer-implemented method of claim 1, wherein the first sensor data comprises at least one of location data, ambient light data, environmental temperature data, device orientation data, or network connectivity data.

4. The computer-implemented method of claim 1, wherein the first ledger engine is configured to record the cryptographically verifiable transaction with a timestamp and a cryptographic hash derived from at least a portion of the first sensor data or at least a portion of the second sensor data.

5. The computer-implemented method of claim 1, further comprising:
verifying synchronization between a second ledger copy and a distributed ledger network; and
in response to detecting that the first ledger is out of synchronization, automatically revoking authorization until synchronization is restored.

6. The computer-implemented method of claim 5, wherein:
the second ledger copy is stored locally on a device associated with the user; and
wherein verifying synchronization further comprises periodically comparing at least one entry of the second ledger copy with at least one entry of the distributed ledger network.

7. The computer-implemented method of claim 1, wherein the plurality of signal features further comprise at least one of a motion signature, physiological parameter, positional pattern, or device-state indicator derived from at least one of the first sensor data and/or the second sensor data.

8. The computer-implemented method of claim 1, wherein the one or more user data containers further comprise metadata defining at least one of a data type identifier, a collection timestamp, a sensor source identifier, a data accuracy score, or a contextual tag associated with the data type identifier.

9. The computer-implemented method of claim 8, further comprising:
enabling, by the one or more processors, a metadata search interface that receives a user-provided description or keyword corresponding to the metadata of the one or more user data containers.

10. The computer-implemented method of claim 8, further comprising:
in response to performing a search of the metadata, generating, by the one or more processors, a summary output identifying one or more of the user data containers that match a query corresponding to the metadata, wherein the summary output is derived from analysis of the metadata stored in the one or more user data containers.

11. The computer-implemented method of claim 1, wherein the one or more user data containers are associated with one or more metadata records linking the one or more user data containers to multiple ledgers corresponding to different data domains.

12. The computer-implemented method of claim 1, further comprising:
generating, by the one or more processors, metadata labels for the first sensor data, the metadata labels comprising at least one of a data type identifier, contextual category, or source identifier, wherein:
the metadata labels are generated without user input based on analysis of one or more characteristics of the first sensor data and/or the second sensor data.

13. The computer-implemented method of claim 1, wherein:
the first sensor data comprises biometric sensor data and contextual sensor data; and
wherein the one or more continuous authentication processes combine a plurality of signal features derived from each of the biometric sensor data and the contextual sensor data to determine the accuracy value.

14. The computer-implemented method of claim 1, wherein comparison of the plurality of signal features with one or more stored reference features is performed during model training to generate a user-specific reference model prior to deployment.

15. The computer-implemented method of claim 1, further comprising:
in response to a determination that the first authentication accuracy value does not satisfy a predefined threshold, generating a secondary action, wherein the secondary action comprises at least one of a session teardown, container lockout, or user prompt for re-authentication.

16. The computer-implemented method of claim 1, wherein the access policy is implemented as a smart contract configured to automatically enforce at least one data sharing term and at least one synchronization event among one or more authorized users.

17. The computer-implemented method of claim 1, further comprising enabling, by the one or more processors, the user to specify an external user to gain access to the one or more user data containers for a defined duration.

18. The computer-implemented method of claim 1, further comprising enabling, by the one or more processors, a third-party application to access the one or more user data containers through at least one of a smart contract or an application programming interface (API).

19. An electronic device comprising:
one or more processors;
memory; and
one or more programs, wherein the one or more programs are stored in the memory and configured to be executed by the one or more processors, the one or more programs including instructions for:
receiving, by one or more processors, first sensor data associated with a user;
extracting, by one or more continuous authentication processes, a plurality of signal features from the first sensor data;
comparing the plurality of signal features with one or more stored reference features derived from prior data of the user;
in accordance with a determination that the plurality of signal features correspond to the one or more stored reference features of the user, determining, by the one or more processors, an accuracy value indicative of verification of a user identity;
computing, based on the accuracy value, a first authentication accuracy value, wherein the first authentication accuracy value represents a probability that the user identity corresponds to an authorized user; and
in accordance with a determination that the first authentication accuracy value satisfies a predefined threshold:
authorizing, by the one or more processors, access to one or more user data containers;
enabling, by the one or more processors via a first ledger engine, in accordance with an access policy stored in a first ledger associated with the first ledger engine, an external computing system to access the one or more user data containers;
recording, by the one or more processors in the first ledger, a cryptographically verifiable transaction corresponding to the access by the external computing system;
in response to receiving second sensor data, computing, by the one or more continuous authentication processes, a second authentication accuracy value based on the second sensor data; and
in accordance with a determination that the second authentication accuracy value satisfies the predefined threshold:
maintaining authorization; and
in accordance with a determination that the second authentication accuracy value does not satisfy the predefined threshold:
revoking authorization.

20. A non-transitory computer-readable medium storing one or more programs, the one or more programs comprising instructions, which when executed by one or more processors of an electronic device, cause the electronic device to:
receive, by one or more processors, first sensor data associated with a user;
extract, by one or more continuous authentication processes, a plurality of signal features from the first sensor data;
compare the plurality of signal features with one or more stored reference features derived from prior data of the user;
in accordance with a determination that the plurality of signal features correspond to the one or more stored reference features of the user, determine, by the one or more processors, an accuracy value indicative of verification of a user identity;
compute, based on the accuracy value, a first authentication accuracy value, wherein the first authentication accuracy value represents a probability that the user identity corresponds to an authorized user; and
in accordance with a determination that the first authentication accuracy value satisfies a predefined threshold:
authorize, by the one or more processors, access to one or more user data containers;
enable, by the one or more processors via a first ledger engine, in accordance with an access policy stored in a first ledger associated with the first ledger engine, an external computing system to access the one or more user data containers;
record, by the one or more processors in the first ledger, a cryptographically verifiable transaction corresponding to the access by the external computing system;
in response to receiving second sensor data, compute, by the one or more continuous authentication processes, a second authentication accuracy value based on the second sensor data; and
in accordance with a determination that the second authentication accuracy value satisfies the predefined threshold:
maintain authorization; and
in accordance with a determination that the second authentication accuracy value does not satisfy the predefined threshold:
revoke authorization.
